(19) United States
(12) Patent Application Publication
(10) Pub. No.: US 2024/0426084 A1
(43) Pub. Date: Dec. 26, 2024

(54) OPERATION ASSISTANCE DEVICE, WORK MACHINE, REMOTE OPERATION ASSISTANCE DEVICE, AND RECORDING MEDIUM

(71) Applicant: SUMITOMO HEAVY INDUSTRIES, LTD., Tokyo (JP)

(72) Inventors: Taira MATSUOKA, Kanagawa (JP); Yuichi AYATO, Kanagawa (JP)

(21) Appl. No.: 18/824,035

(22) Filed: Sep. 4, 2024

Related U.S. Application Data
(63) Continuation of application No. PCT/JP2023/008849, filed on Mar. 8, 2023.

(30) Foreign Application Priority Data
Mar. 9, 2022 (JP) 2022-036078
Mar. 30, 2022 (JP) 2022-057576

(51) Int. Cl. E02F 9/26; E02F 9/20; E02F 9/22; E02F 9/24; G07C 5/08

(52) U.S. Cl. CPC E02F 9/261; E02F 9/2025; E02F 9/205; E02F 9/24; G07C 5/0816; E02F 9/2228; E02F 9/2285; E02F 9/2292; E02F 9/2296

(57) ABSTRACT

A work machine includes circuitry configure to receive an operation input by a user with respect to the work machine; receive an instruction relating to an operation of the work machine from outside the work machine; and notify the user of the received instruction relating to the operation of the work machine.

### CROSS-REFERENCE TO RELATED APPLICATIONS

The present application is a continuation application of International Application No. PCT/JP2023/008849 filed on Mar. 8, 2023, which is based on and claims priority to Japanese Patent Application No. 2022-036078, filed on Mar. 9, 2022, and Japanese Patent Application No. 2022-057576, filed on Mar. 30, 2022. The contents of these applications are incorporated herein by reference in their entirety.

### BACKGROUND

### 1. Technical Field

The present disclosure relates to an operation assistance device for a work machine and the like.

### 2. Description of Related Art

There is disclosed a known technique for operating a work machine in response to instructions from outside of the work machine.

Such a known technique discloses a technique of recognizing actions (gestures) of a worker based on time-series image information (moving image information) around a work machine (shovel) and operating the work machine according to the actions.

### SUMMARY

According to one embodiment of the present disclosure, a work machine includes circuitry configure to:
receive an operation input by a user with respect to the work machine;
receive an instruction relating to an operation of the work machine from outside the work machine; and
notify the user of the received instruction relating to the operation of the work machine.

### BRIEF DESCRIPTION OF THE DRAWINGS

FIG. 1 is a diagram illustrating an example of an activation assistance system.

FIG. 2 is a top view illustrating an example of a shovel.

FIG. 3 is a diagram illustrating an example of a configuration relating to remote operation of the shovel.

FIG. 4 is a block diagram illustrating an example of a hardware configuration of the shovel.

FIG. 5 is a diagram illustrating an example of a hardware configuration of an information processing device.

FIG. 6 is a functional block diagram illustrating a first example of a functional configuration of an operation assistance device.

FIG. 7 is a diagram illustrating an example of an operation instruction notification screen displayed on a display device.

FIG. 8 is a functional block diagram illustrating a second example of a functional configuration of the operation assistance device.

FIG. 9 is a diagram illustrating another example of a work machine.

FIG. 10 is a diagram illustrating an example of a remote operation system for a shovel.

FIG. 11 is a block diagram illustrating an example of a hardware configuration of a remote operation assistance device.

FIG. 12 is a functional block diagram illustrating an example of a functional configuration relating to a surrounding monitoring function of the shovel.

FIG. 13 is a flowchart schematically illustrating an example of authentication processing of a person (operator of remote operation) around the shovel.

FIG. 14 is a diagram illustrating an example of a security system for a shovel.

FIG. 15 is a block diagram illustrating another example of the hardware configuration of the shovel.

FIG. 16 is a functional block diagram illustrating an example of a configuration relating to a security function of the shovel.

### DETAILED DESCRIPTION

In the disclosed known technique, for example, when instructions are received from outside of the work machine and the work machine is operated directly, blind spots may exist around the work machine, such as a place in the back of the work machine, depending on the position of a person who gives the instructions. As a result, an appropriate operation may not be performed according to situations around the work machine. Further, for example, when instructions are given from outside of the work machine by human actions such as gestures, and the work machine is directly operated, movement of the work machine may not be appropriately controlled depending on the recognition accuracy or the like.

Thus, it is desirable to provide a technique capable of more appropriately control movement of a work machine in response to instructions from outside of the work machine.

According to the above-described embodiments, the movement of the work machine can be controlled more appropriately by instructions from outside of the work machine.

Hereinafter, embodiments will be described with reference to the accompanying drawings.

### [Overview of Activation Assistance System]

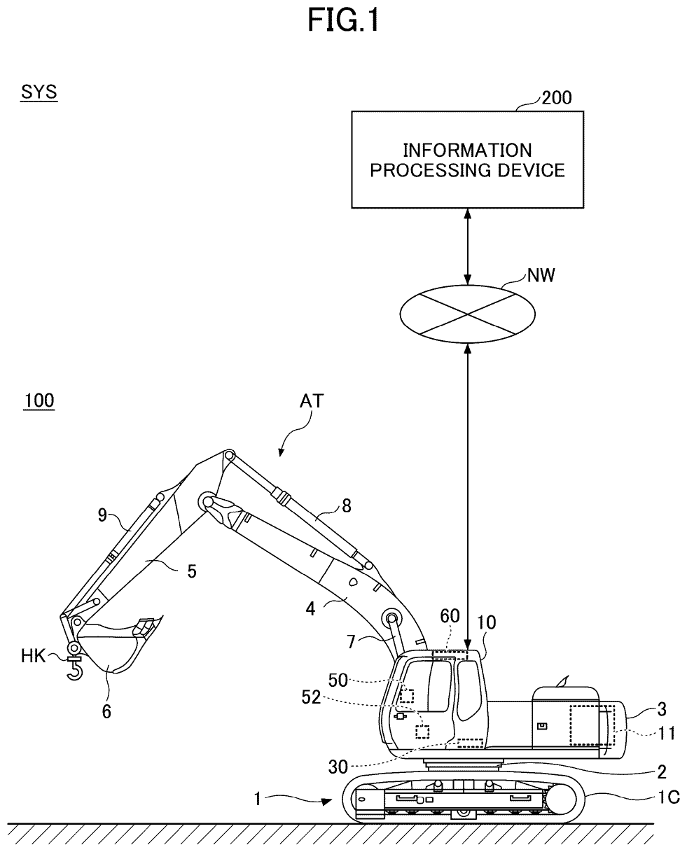

First, an overview of an activation assistance system SYS according to the present embodiment will be described with reference to FIGS. 1 to 3.

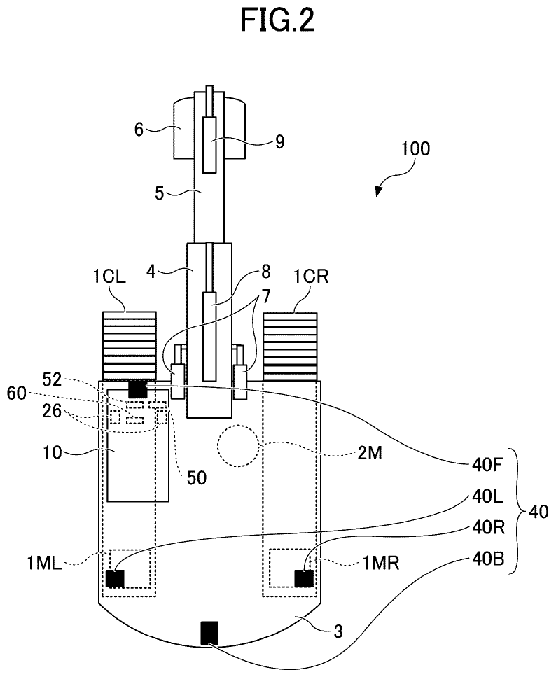

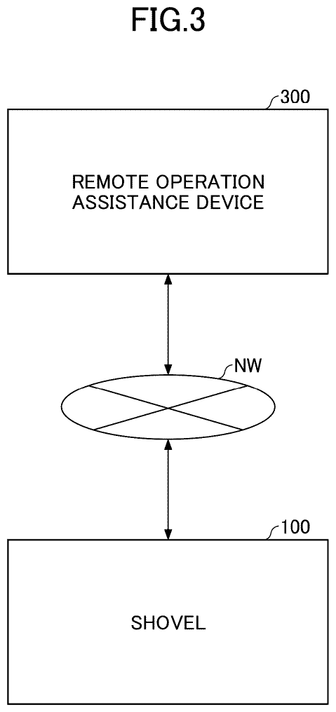

FIG. 1 is a diagram illustrating an example of an activation assistance system SYS. In FIG. 1, a shovel 100 is illustrated in a left side view. FIG. 2 is a top view illustrating an example of the shovel 100. FIG. 3 is a diagram illustrating an example of a configuration relating to remote operation of the shovel. Hereinafter, a direction in the shovel 100 or a direction viewed from the shovel 100 may be described by defining a direction in which the attachment AT extends in a top view of the shovel 100 (an upper direction in FIG. 2) as “front”.

As illustrated in FIG. 1, the activation assistance system SYS includes the shovel 100 and an information processing device 200.

The activation assistance system SYS collaborates with the shovel 100 using the information processing device 200 and assists an activation of the shovel 100.

The number of shovels 100 included in the activation assistance system SYS may be one or more.

The shovel 100 is a work machine that is subject to assistance relating to activation in the activation assistance system SYS.

As illustrated in FIGS. 1 and 2, the shovel 100 includes a lower traveling body 1; an upper turning body 3; an attachment AT including a boom 4, an arm 5, and a bucket 6; and a cabin 10.

The lower traveling body 1 causes the shovel 100 to travel by using the crawler 1C. The crawler 1C includes a left crawler 1CL and a right crawler 1CR. The left crawler 1CL is hydraulically driven by a traveling hydraulic motor 1ML. Similarly, the right crawler 1CR is hydraulically driven by the traveling hydraulic motor 1MR. Thus, the lower traveling body 1 can travel by itself.

The upper turning body 3 is turnably mounted on the lower traveling body 1 via a turning mechanism 2. For example, the upper turning body 3 turns with respect to the lower traveling body 1 by the turning mechanism 2 being hydraulically driven by a turning hydraulic motor 2M.

The boom 4 is attached to the center of the front portion of the upper turning body 3 so as to be able to be raised and lowered about a rotation axis along the left-right direction. The arm 5 is attached to the distal end of the boom 4 so as to be rotatable about a rotation axis along the left-right direction. The bucket 6 is attached to the distal end of the arm 5 so as to be rotatable about a rotation axis along the left-right direction.

The bucket 6 is an example of an end attachment and is used for, for example, excavation work.

A hook HK for crane work (hoisting work) is attached to the bucket 6. Thus, the shovel 100 can perform crane work (lifting work) of suspending a load on the hook HK and operating at least one of the lower traveling body 1, the upper turning body 3, or the attachment AT to convey a hoisting load to a predetermined conveyance destination.

The hook HK has a base end rotatably connected to a bucket pin connecting the arm 5 and the bucket 6. Thus, when work other than crane work such as excavation work is performed, the hook HK can be housed in a space formed between two bucket links.

The bucket 6 is attached to the distal end of the arm 5 in a manner that the bucket 6 can be appropriately replaced according to the work content of the shovel 100. That is, instead of the bucket 6, a bucket of a type different from the bucket 6, for example, a relatively large bucket, a slope bucket, a dredging bucket, or the like may be attached to the distal end of the arm 5. Further, an end attachment of a type other than the bucket, for example, a stirrer, a breaker, a crusher, or the like may be attached to the distal end of the arm 5. Further, for example, an auxiliary attachment such as a quick coupling or a tilt rotator may be provided between the arm 5 and the end attachment.

The boom 4, the arm 5, and the bucket 6 are hydraulically driven by a boom cylinder 7, an arm cylinder 8, and a bucket cylinder 9, respectively.

The cabin 10 is a control room for an operator to board and operate the shovel 100. The cabin 10 is mounted on, for example, the left side of the front portion of the upper turning body 3.

For example, the shovel 100 operates driven elements such as the lower traveling body 1 (that is, the pair of left and right crawlers 1CL and 1CR), the upper turning body 3, the boom 4, the arm 5, and the bucket 6 in response to an operation of an operator who boards the cabin 10.

Further, the shovel 100 may be configured to be remotely operated from outside of the shovel 100 instead of or in addition to being configured to be operable by the operator boarding the cabin 10. When the shovel 100 is remotely operated, the inside of the cabin 10 may be unmanned. Hereinafter, the description will be given on the assumption that the operation by the operator includes at least one of the operation by the operator of the cabin 10 on an operation device 26 or a remote operation of an external operator.

For example, as illustrated in FIG. 3, the remote operation includes a mode in which the shovel 100 is operated by an operation input relating to the actuator of the shovel 100 performed by a remote operation assistance device 300.

The remote operation assistance device 300 is provided in, for example, a management center that manages the work of the shovel 100 from the outside. The remote operation assistance device 300 may be a portable operation terminal. In this case, the operator can remotely operate the shovel 100 while directly checking the working situation of the shovel 100 from the surroundings of the shovel 100.

The shovel 100 may transmit an image (hereinafter, referred to as a “surrounding image”) representing a surrounding area including the front of the shovel 100 based on the captured image output by an imaging device 40 described later to the remote operation assistance device 300 through a communication line NW using a communication device 60 described later, for example. Then, the remote operation assistance device 300 may display the image (surrounding image) received from the shovel 100 on the display device. Further, various information images (information screens) displayed on an output device 50 (display device) inside the cabin 10 of the shovel 100 may be similarly displayed on the display device of the remote operation assistance device 300. Thus, the operator who uses the remote operation assistance device 300 can remotely operate the shovel 100 while checking the display content such as an image or an information screen representing the surrounding area of the shovel 100 displayed on the display device. The shovel 100 may activate an actuator in response to a remote operation signal indicating a remote operation content received from the remote operation assistance device 300 by the communication device 60, and drive the driven elements such as the lower traveling body 1, the upper turning body 3, the boom 4, the arm 5, or the bucket 6.

The remote operation may include, for example, a mode in which the shovel 100 is operated by voice input, gesture input, or the like from outside to the shovel 100 by a person (e.g., a worker) around the shovel 100. Specifically, the shovel 100 recognizes a voice uttered by a worker or the like around the shovel 100, a gesture performed by the worker or the like, and the like through a voice input device (e.g., a microphone), a gesture input device (e.g., an imaging device), and the like mounted on the shovel 100. The shovel 100 may activate the actuators according to the recognized contents of the voice, the gesture, and the like, and drive the driven elements such as the lower traveling body 1 (the left and right crawlers 1C), the upper turning body 3, the boom 4, the arm 5, and the bucket 6.

The work of the shovel 100 may be remotely monitored. In this case, a remote monitoring assistance device having the same function as the remote operation assistance device 300 may be provided. The remote monitoring assistance device is, for example, an information processing device 200. Thus, a monitoring person who is a user of the remote monitoring assistance device can monitor the working situation of the shovel 100 while checking the surrounding image displayed on the display device of the remote monitoring assistance device. Further, for example, when the monitoring person determines that the monitoring is necessary from the viewpoint of safety, the monitoring person can perform a predetermined input using the input device of the remote monitoring assistance device to intervene in the operation of the shovel 100 by the operator and perform an emergency stop.

The information processing device 200 communicates with the shovel 100 through the communication line NW to collaborate with each other and assist the activation of the shovel 100.

The information processing device 200 is, for example, a server or a terminal device for management installed in a management office in a work site of the shovel 100 or a management center or the like that is located at a place different from the work site of the shovel 100 and manages an activation state or the like of the shovel 100. The terminal device for management may be, for example, a stationary terminal device such as a desktop personal computer (PC) or a portable terminal device (mobile terminal) such as a tablet terminal, a smartphone, or a laptop PC. In the latter case, a worker at the work site, a supervisor who supervises the work, a manager who manages the work site, or the like can move in the work site while carrying the portable information processing device 200. In the latter case, the operator can bring the portable information processing device 200 into the cabin of the shovel 100, for example.

The information processing device 200 acquires data relating to an activation state from the shovel 100, for example. Thus, the information processing device 200 can grasp the activation state of the shovel 100 and monitor the presence or absence of abnormality of the shovel 100. The information processing device 200 can display data relating to the activation state of the shovel 100 through a display device 208 to be described later and cause the user to check the data.

Further, the information processing device 200 transmits various data such as programs and reference data used in the processing of a controller 30 and the like to the shovel 100, for example. Thus, the shovel 100 can perform various processes relating to the activation of the shovel 100 using various data downloaded from the information processing device 200.

### [Hardware Configuration of Activation Assistance System]

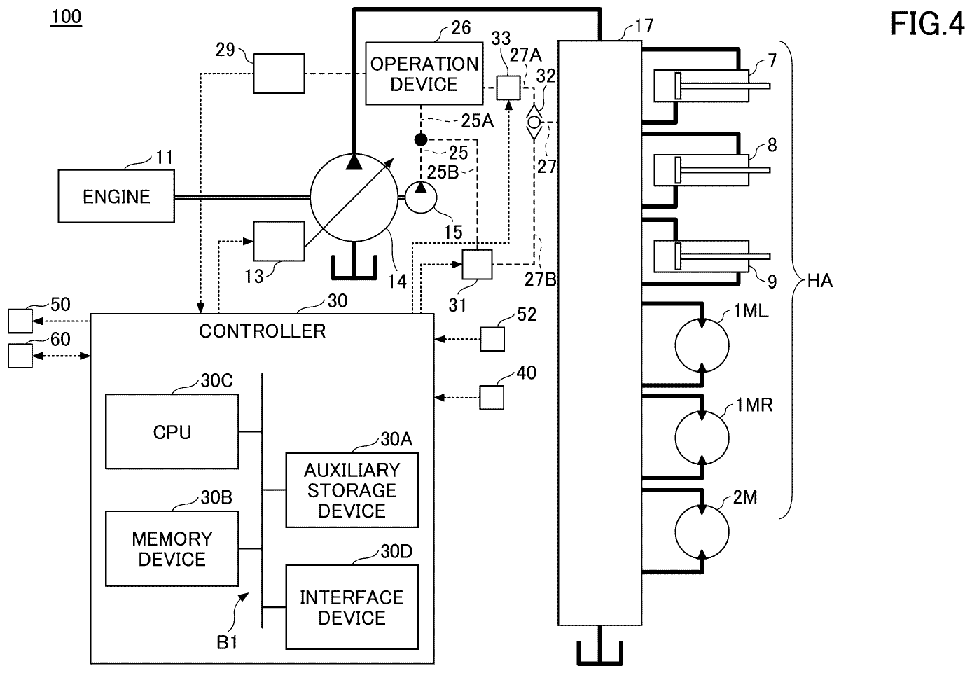

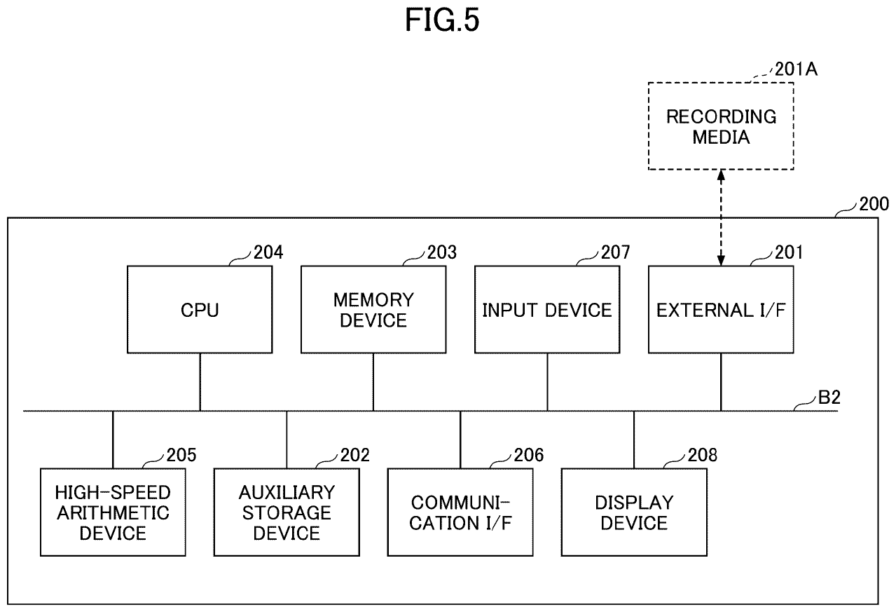

Next, a hardware configuration of the activation assistance system SYS will be described with reference to FIGS. 4 and 5 in addition to FIGS. 1 to 3.

### <Hardware Configuration of Shovel>

FIG. 4 is a block diagram illustrating an example of a hardware configuration of the shovel 100.

In FIG. 4, a path through which mechanical power is transmitted is indicated by a double line, a path through which high-pressure hydraulic oil for driving the hydraulic actuator flows is indicated by a solid line, a path through which pilot pressure is transmitted is indicated by a broken line, and a path through which an electric signal is transmitted is indicated by a dotted line.

The shovel 100 includes respective components such as a hydraulic drive system relating to hydraulic drive of a driven element, an operation system relating to activation of the driven element, a user interface system relating to exchange of information with a user, a communication system relating to communication with the outside, and a control system relating to various controls.

### <<Hydraulic Drive System>>

As illustrated in FIG. 4, the hydraulic drive system of the shovel 100 includes hydraulic actuators HA that hydraulically drive the driven elements such as the lower traveling body 1 (the left and right crawlers 1C), the upper turning body 3, and the attachment AT, as described above. The hydraulic drive system of the shovel 100 according to the present embodiment includes an engine 11, a regulator 13, a main pump 14, and a control valve 17.

The hydraulic actuators HA include traveling hydraulic motors 1ML and 1MR, the turning hydraulic motor 2M, a boom cylinder 7, an arm cylinder 8, a bucket cylinder 9, and the like.

In the shovel 100, a part or all of the hydraulic actuators HA may be replaced with electric actuators. That is, the shovel 100 may be a hybrid shovel or an electric shovel.

The engine 11 is a motor of the shovel 100 and is a main power source in a hydraulic drive system. The engine 11 is, for example, a diesel engine using light oil as fuel. The engine 11 is mounted on, for example, a rear portion of the upper turning body 3. The engine 11 rotates at a constant target rotation speed set in advance under direct or indirect control by the controller 30 described later, and drives the main pump 14 and the pilot pump 15.

Note that, instead of or in addition to the engine 11, another motor (e.g., an electric motor) or the like may be mounted on the shovel 100.

The regulator 13 controls (adjusts) a discharge amount of the main pump 14 under the control of the controller 30. For example, the regulator 13 adjusts the angle of the swash plate of the main pump 14 (hereinafter, referred to as “tilt angle”) in response to a control instruction from the controller 30.

The main pump 14 supplies the hydraulic oil to the control valve 17 through a high-pressure hydraulic line. The main pump 14 is mounted, for example, on a rear portion of the upper turning body 3, similarly to the engine 11. The main pump 14 is driven by the engine 11 as described above. The main pump 14 is, for example, a variable displacement hydraulic pump, and as described above, the stroke length of the piston is adjusted by the tilting angle of the swash plate being adjusted by the regulator 13 under the control of the controller 30, and the discharge flow rate and the discharge pressure are controlled.

The control valve 17 drives the hydraulic actuator HA according to the content of the operation of the remote operation performed by the operator on the operation device 26. The control valve 17 is mounted, for example, in a central portion of the upper turning body 3. As described above, the control valve 17 is connected to the main pump 14 via the high-pressure hydraulic line, and selectively supplies the hydraulic oil supplied from the main pump 14 to each hydraulic actuator in response to the operation by the operator. Specifically, the control valve 17 includes a plurality of control valves (also referred to as “directional switching valves”) that control the flow rate and the flow direction of the hydraulic oil supplied from the main pump 14 to each of the hydraulic actuators HA.

### <<Operation System>>

As illustrated in FIG. 4, the operation system of the shovel 100 includes the pilot pump 15, the operation device 26, a hydraulic control valve 31, a shuttle valve 32, and a hydraulic control valve 33.

The pilot pump 15 supplies a pilot pressure to various hydraulic devices via a pilot line 25. The pilot pump 15 is mounted, for example, on the rear portion of the upper turning body 3, similarly to the engine 11. The pilot pump 15 is, for example, a fixed displacement hydraulic pump, and is driven by the engine 11 as described above.

The pilot pump 15 may be omitted. In this case, the hydraulic oil at a relatively low pressure, which is obtained by reducing the pressure of the hydraulic oil at a relatively high pressure discharged from the main pump 14 by a predetermined pressure reducing valve, may be supplied to various hydraulic devices as the pilot pressure.

The operation device 26 is provided near the operator's seat of the cabin 10 and is used by the operator to operate various driven elements. Specifically, the operation device 26 is used for an operator to operate the hydraulic actuator HA that drives each driven element, and as a result, the operation by the operator of the driven element to be driven by the hydraulic actuator HA can be implemented. The operation device 26 includes a pedal device and a lever device for operating each driven element (hydraulic actuator HA).

For example, as illustrated in FIG. 4, the operation device 26 is a hydraulic pilot type. Specifically, the operation device 26 uses the hydraulic oil supplied by the pilot pump 15 through the pilot line 25 and a pilot line 25A, which branches off from the pilot line 25, to output a pilot pressure corresponding to the operation content to a pilot line 27A. The pilot line 27A is connected to one of inlet ports of the shuttle valve 32, and is connected to the control valve 17 via a pilot line 27 connected to an outlet port of the shuttle valve 32. Thus, the pilot pressure corresponding to the operation content relating to various driven elements (hydraulic actuators HA) in the operation device 26 can be input to the control valve 17 via the shuttle valve 32. Therefore, the control valve 17 can drive each hydraulic actuator HA according to the operation content of the operation device 26 by the operator or the like.

The operation device 26 may be an electric type. In this case, the pilot line 27A, the shuttle valve 32, and a hydraulic control valve 33 are omitted. Specifically, the operation device 26 outputs an electric signal (hereinafter, referred to as an “operation signal”) corresponding to the operation content, and the operation signal is input to the controller 30. The controller 30 outputs a control instruction corresponding to the content of the operation signal, that is, a control signal corresponding to the operation content with respect to the operation device 26 to the hydraulic control valve 31. Thus, the pilot pressure corresponding to the operation content of the operation device 26 is input from the hydraulic control valve 31 to the control valve 17, and the control valve 17 can drive each hydraulic actuator HA according to the operation content of the operation device 26.

Further, the control valve (directional switching valve) built in the control valve 17 for driving each hydraulic actuator HA may be an electromagnetic solenoid type. In this case, the operation signal output from the operation device 26 may be directly input to the control valve 17, that is, an electromagnetic solenoid type control valve.

As described above, a part or all of the hydraulic actuators HA may be replaced with electric actuators. In this case, the controller 30 may output a control instruction corresponding to the operation content of the operation device 26 or the remote operation content defined by the remote operation signal to the electric actuator or a driver or the like that drives the electric actuator. In addition, when the shovel 100 is remotely operated, the operation device 26 may be omitted.

The hydraulic control valve 31 is provided for each driven element (hydraulic actuator HA) to be operated by the operation device 26 and for each driving direction (e.g., the raising direction and the lowering direction of the boom 4) of the driven element (hydraulic actuator HA). That is, two hydraulic control valves 31 are provided for each double-acting hydraulic actuator HA. The hydraulic control valves 31 may be provided, for example, in a pilot line 25B between the pilot pump 15 and the control valve 17, and may be configured to be able to change a flow passage area (that is, a cross-sectional area through which the hydraulic oil can flow). Thus, the hydraulic control valves 31 can each output a predetermined pilot pressure to the pilot line 25B on the secondary side by using the hydraulic oil of the pilot pump 15 supplied through the pilot line 278. Therefore, the hydraulic control valves 31 can each indirectly apply a predetermined pilot pressure corresponding to a control signal from the controller 30 to the control valve 17 through the shuttle valves 32 between the pilot line 27B and the pilot line 27.

The controller 30 controls, for example, the hydraulic control valve 31 to implement remote operation of the shovel 100. Specifically, the controller 30 outputs a control signal corresponding to the remote operation content specified by the remote operation signal received from the remote operation assistance device 300 to the hydraulic control valve 31 by the communication device 60. Thus, the controller 30 can cause the hydraulic control valve 31 to supply the pilot pressure corresponding to the remote operation content to the control valve 17, and can implement movement of the shovel 100 based on the remote operation by the operator.

In addition, when the operation device 26 is an electric type, the controller 30 can cause the hydraulic control valve 31 to directly supply the pilot pressure corresponding to the operation content (operation signal) of the operation device 26 to the control valve 17, and implement the movement of the shovel 100 based on the operation by the operator.

The shuttle valve 32 has two inlet ports and one outlet port, and outputs the hydraulic oil having a higher pilot pressure of the pilot pressures input to the two inlet ports to the outlet port. The shuttle valve 32 is provided for each driven element (hydraulic actuator HA) to be operated by the operation device 26 and for each driving direction of the driven element (hydraulic actuator HA). One of two inlet ports of the shuttle valve 32 is connected to the pilot line 27A on the secondary side of the operation device 26 (specifically, the above-described lever device or pedal device included in the operation device 26), and the other inlet port is connected to a pilot line 278 on the secondary side of the hydraulic control valve 31. The outlet port of the shuttle valve 32 is connected to the pilot port of the corresponding control valve of the control valve 17 through the pilot line 27. The corresponding control valve is a control valve that drives a hydraulic actuator subject to operation by the above-described lever device or pedal device connected to one inlet port of the shuttle valve 32. Thus, each of these shuttle valves 32 allows the higher one of the pilot pressure of the pilot line 27A on the secondary side of the operation device 26 and the pilot pressure of the pilot line 27B on the secondary side of the hydraulic control valve 31 to act on the pilot port of the corresponding control valve. That is, the controller 30 can control the corresponding control valve without depending on the operation of the operation device 26 by the operator by outputting the pilot pressure higher than the pilot pressure on the secondary side of the operation device 26 from the hydraulic control valve 31. Therefore, the controller 30 can control the operations of the driven elements (the lower traveling body 1, the upper turning body 3, and the attachment AT) regardless of the activation state of the operator on the operation device 26, and can implement the remote operation function.

The hydraulic control valve 33 is provided in the pilot line 27A that connects the operation device 26 and the shuttle valve 32. The hydraulic control valve 33 is configured to be able to change, for example, a flow passage area of the hydraulic control valve 33. The hydraulic control valve 33 operates in response to a control signal input from the controller 30. Thus, the controller 30 can forcibly reduce the pilot pressure output from the operation device 26 when the operation device 26 is operated by the operator. Therefore, even when the operation device 26 is operated, the controller 30 can forcibly restrict or stop the operation of the hydraulic actuator corresponding to the operation of the operation device 26. Further, for example, even when the operation device 26 is operated, the controller 30 can reduce the pilot pressure output from the operation device 26 to be lower than the pilot pressure output from the hydraulic control valve 31. Therefore, the controller 30 can reliably apply a desired pilot pressure to the pilot port of the control valve in the control valve 17, for example, regardless of the operation content of the operation device 26 by controlling the hydraulic control valve 31 and the hydraulic control valve 33. Therefore, the controller 30 can more appropriately implement the remote operation function of the shovel 100 by controlling the hydraulic control valve 33 in addition to the hydraulic control valve 31, for example.

### <<User Interface System>>

As illustrated in FIG. 4, a user interface system of the shovel 100 includes the operation device 26, the output device 50, and an input device 52.

The output device 50 outputs various kinds of information to a user of the shovel 100 (e.g., an operator of the cabin 10 or an operator of an external remote operation), a person around the shovel 100 (e.g., a worker or a driver of a work vehicle), or the like.

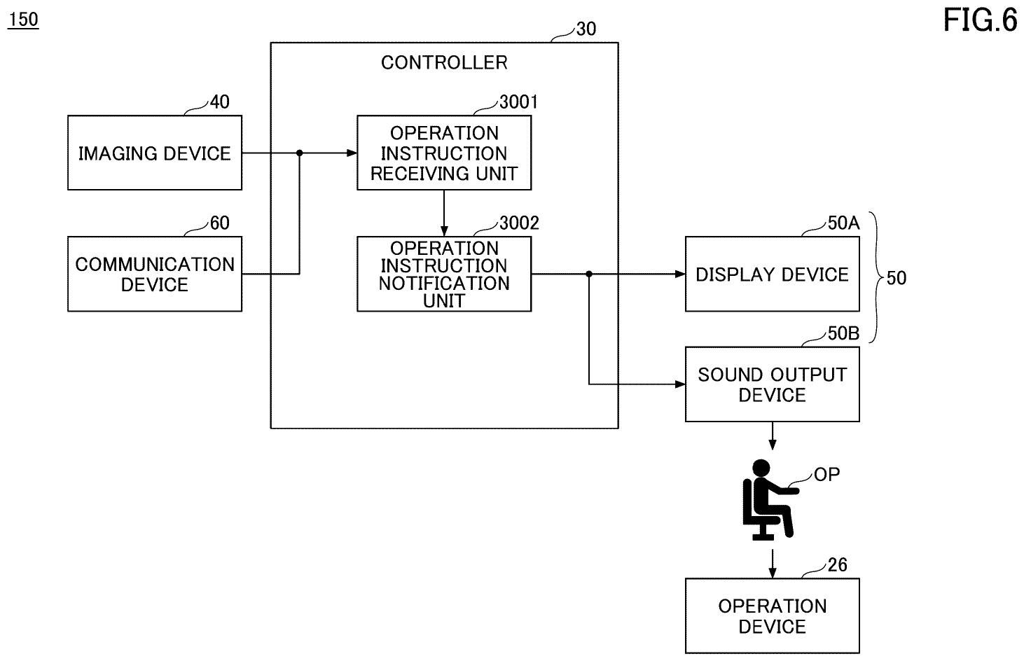

For example, the output device 50 includes an illumination device, a display device 50A (see FIG. 6), or the like that outputs various kinds of information in a visual manner. The illumination device is, for example, a warning lamp (indicator lamp) or the like. The display device 50A is, for example, a liquid-crystal display, an organic electroluminescence (EL) display, or the like. For example, as illustrated in FIG. 2, the illumination device and the display device 50A may be provided inside the cabin 10, and output various kinds of information to an operator or the like inside the cabin 10 in a visual manner. The illumination device and the display device 50A may be provided on, for example, a side surface of the upper turning body 3, and may output various kinds of information to an operator or the like around the shovel 100 in a visual manner.

Further, for example, the output device 50 includes a sound output device 50B (see FIG. 6) that outputs various kinds of information in an auditory manner. The sound output device 50B includes, for example, a buzzer, a speaker, and the like. The sound output device 50B may be provided, for example, at least one of inside or outside of the cabin 10, and output various kinds of information to the operator inside the cabin 10 and a person (worker or the like) around the shovel 100 by an auditory method.

Further, for example, the output device 50 may include a device that outputs various kinds of information in a tactile manner such as vibration of the operator's seat.

The input device 52 receives various inputs from the user of the shovel 100, and signals corresponding to the received inputs are incorporated into the controller 30. The input device 52 is provided inside the cabin 10, for example, and receives an input from an operator or the like inside the cabin 10. The input device 52 may be provided on, for example, a side surface of the upper turning body 3 and may receive an input from an operator or the like around the shovel 100.

For example, the input device 52 includes an operation input device that receives an input by a mechanical operation from the user. The operation input device may include a touch panel mounted on the display device, a touch pad installed around the display device, a button switch, a lever, a toggle, a knob switch provided in the operation device 26 (lever device), and the like.

Further, for example, the input device 52 may include a voice input device that receives a voice input of the user. The voice input device includes, for example, a microphone.

Further, for example, the input device 52 may include a gesture input device that receives a gesture input of the user. The gesture input device includes, for example, an imaging device that images a state of a gesture performed by the user.

Further, for example, the input device 52 may include a biometric input device that receives a biometric input of the user. The biometric input includes, for example, input of biometric information such as a fingerprint or an iris of the user.

### <<Communication System>>

As illustrated in FIG. 4, a communication system of the shovel 100 according to the present embodiment includes the communication device 60.

The communication device 60 is connected to an external communication line NW and communicates with a device provided separately from the shovel 100. The device provided separately from the shovel 100 may include a portable terminal device (mobile terminal) brought into the cabin 10 by the user of the shovel 100, in addition to the device outside the shovel 100. The communication device 60 may include, for example, a mobile communication module complying with a standard such as 4G (4^{th} Generation) or 5G (5^{th} Generation). The communication device 60 may include, for example, a satellite communication module. The communication device 60 may include, for example, a WiFi communication module or a Bluetooth (registered trademark) communication module. The communication device 60 may include a plurality of communication devices according to the communication line NW to be connected.

For example, the communication device 60 communicates with an external device such as the information processing device 200 or the remote operation assistance device 300 in the work site through a local communication line NW constructed in the work site. The local communication line NW is, for example, a mobile communication line of a local 5G (what is known as local 5G) constructed at a work site or a local area network (LAN) of a WiFi6.

For example, the communication device 60 communicates with the information processing device 200, the remote operation assistance device 300, and the like outside the work site through a communication line NW of a wide area including the work site, that is, a wide area network (WAN). The wide area network includes, for example, a wide area mobile communication network, a satellite communication network, the Internet, and the like.

### <<Control System>>

As illustrated in FIG. 4, a control system of the shovel 100 includes the controller 30. The control system of the shovel 100 according to the present embodiment includes an operation pressure sensor 29 and the imaging device 40.

The controller various controls 30 performs relating to the shovel 100.

The functions of the controller 30 may be implemented by given hardware, or a combination of given hardware and software, or the like. For example, as illustrated in FIG. 4, the controller 30 includes an auxiliary storage device 30A, a memory device 30B, a central processing unit (CPU) 30C, and an interface device 30D, which are connected to each other via a bus B1.

The auxiliary storage device 30A is a non-volatile storage unit, and stores a program to be installed. The auxiliary storage device 30A is, for example, an electrically erasable programmable read-only memory (EEPROM), a flash memory, or the like.

The memory device 30B loads a program in the auxiliary storage device 30A so that the CPU 30C can read the program, for example, when an instruction to start the program is given. The memory device 30B is, for example, a static random access memory (SRAM).

The CPU 30C executes, for example, a program loaded into the memory device 30B, and implements various functions of the controller 30 according to instructions of the program.

The interface device 30D functions as, for example, a communication interface for connection to a communication line inside the shovel 100. The interface device 30D may include a plurality of different types of communication interfaces according to the type of communication line to be connected.

The interface device 30D functions as an external interface for reading and writing of information from and to recording media. The recording medium is, for example, a dedicated tool that is connected to a connector installed inside the cabin 10 by a detachable cable. The recording medium may be a general-purpose recording medium such as an SD memory card or a universal serial bus (USB) memory. Thus, the program for implementing various functions of the controller 30 can be provided by, for example, portable recording media and installed in the auxiliary storage device 30A of the controller 30. The program may be downloaded from another computer outside the shovel 100 through the communication device 60 and installed in the auxiliary storage device 30A.

Note that some of the functions of the controller 30 may be implemented by another controller (control device). That is, the functions of the controller 30 may be implemented by a plurality of controllers in a distributed manner.

The operation pressure sensor 29 detects a pilot pressure on the secondary side (pilot line 27A) of the hydraulic pilot-type operation device 26, that is, a pilot pressure corresponding to the activation state of each of the driven elements (hydraulic actuators) in the operation device 26. A detection signal of the pilot pressure corresponding to the activation state of each driven element (hydraulic actuator HA) in the operation device 26, which is detected by the operation pressure sensor 29 is incorporated into the controller 30.

When the operation device 26 is an electric type, the operation pressure sensor 29 is omitted. This is because the controller 30 can grasp the activation state of each driven element through the operation device 26 based on the operation signal acquired from the operation device 26.

The imaging device 40 acquires an image of the surroundings of the shovel 100. The imaging device 40 may acquire (generate) three dimensional data (hereinafter, simply referred to as “three dimensional data of an object”) indicating the position and the outer shape of an object around the shovel 100 in the imaging range (angle of view) based on the acquired image and data relating to a distance described later. The three dimensional data of the object around the shovel 100 is, for example, data of coordinate information of a point group representing the surface of the object, distance image data, or the like.

For example, as illustrated in FIG. 2, the imaging device 40 includes a camera 40F that images the front of the upper turning body 3, a camera 40B that images the rear of the upper turning body 3, a camera 40L that images the left side of the upper turning body 3, and a camera 40R that images the right side of the upper turning body 3. Thus, the imaging device 40 can image the entire circumference around the shovel 100 with the shovel 100 being at the center, that is, an angular direction range over of 360 degrees when viewed from above the shovel 100. The operator can visually recognize the captured images of the cameras 40B, 40L, and 40R and the surrounding images such as the processed images generated based on the captured images through the output device 50 (the displaying device) and the remote operation assistance device 300, and can check the states of the left side, the right side, and the rear side of the upper turning body 3. Further, the operator can remotely operate the shovel 100 while checking the movement of the attachment AT including the bucket 6 by visually recognizing the captured image of the camera 40F and the surrounding images such as the processed images generated based on the captured images through the remote operation assistance device 300. Hereinafter, the cameras 40F, 40B, 40L, and 40R may be collectively or individually referred to as a “camera 40X”.

The camera 40X is, for example, a monocular camera. The camera 40X may be a stereo camera or a TOF (Time of Flight) camera. The camera may be capable of acquiring depth information in addition to a two-dimensional image, as in a camera or the like (hereinafter collectively referred to as a “3D camera”).

The controller 30 receives the image captured by the imaging device 40 (camera 40X) via a one-to-one communication line or an in-vehicle network. Thus, for example, the controller 30 can monitor an object around the shovel 100 based on the camera 40X. Further, for example, the controller 30 can determine the surrounding environment of the shovel 100 based on the camera 40X. In addition, for example, the controller 30 can determine the posture state of the attachment AT illustrated in the captured image based on the camera 40X (camera 40F). Further, for example, the controller 30 can determine the posture state of the machine body (the upper turning body 3) of the shovel 100 with reference to an object around the shovel 100.

Note that some of the cameras 40F, 40B, 40L, and 40R may be omitted. For example, when the remote operation of the shovel 100 is not performed, the camera 40F and the camera 40L may be omitted. This is because the operator of the cabin 10 can relatively easily check the states of the front and the left side of the shovel 100. Instead of or in addition to the imaging device 40 (camera 40X), a distance sensor may be provided in the upper turning body 3. The distance sensor is attached to, for example, an upper portion of the upper turning body 3, and acquires data relating to the distance and direction of an object in the area around the shovel 100. The distance sensor may acquire (generate) three-dimensional data (e.g., data of coordinate information of a point group) of an object in the area around the shovel 100 within the sensing range based on the acquired data. The distance sensor is, for example, a light detection and ranging (LIDAR). Further, for example, the distance sensor may be a millimeter wave radar, an ultrasonic sensor, an infrared sensor, or the like.

### <Hardware Configuration of Information Processing Device>

FIG. 5 is a block diagram illustrating an example of a hardware configuration of the information processing device 200.

The functions of the information processing device 200 are implemented by any given hardware, a combination of any given hardware and software, or the like. For example, as illustrated in FIG. 5, the information processing device 200 includes an external interface 201, an auxiliary storage device 202, a memory device 203, a CPU 204, a high-speed arithmetic device 205, a communication interface 206, an input device 207, and a display device 208, which are connected via a bus B2.

The external interface 201 functions as an interface for reading from a recording media 201A and writing to the recording media 201A. The recording media 201A include, for example, flexible disks, CDs (Compact Discs), DVDs (Digital Versatile Discs), BD (Blu-ray (trademark) Disc), SD memory cards, USB-type memories, and the e like. The information processing device 200 can read various kinds of information used in processing through the recording media 201A, store the information in the auxiliary storage device 202, and install programs for implementing various functions.

The information processing device 200 may acquire various data and programs used in processing from an external device via the communication interface 206.

The auxiliary storage device 202 stores the installed various programs, and also stores files, data, and the like necessary for various processes. The auxiliary storage device 202 includes, for example, a hard disk drive (HDD), a solid state drive (SSD), a flash memory, or the like.

When an instruction to activate a program is issued, the memory device 203 reads the program from the auxiliary storage device 202 and stores the program. The memory device 203 includes, for example, a dynamic random access memory (DRAM) or an SRAM.

The CPU 204 executes various programs loaded from the auxiliary storage device 202 to the memory device 203 and implements various functions relating to the information processing device 200 according to the programs.

The high-speed arithmetic device 205 performs arithmetic processing at a relatively high speed in conjunction with the CPU 204. The high-speed arithmetic device 205 includes, for example, a graphics processing unit (GPU), an application specific integrated circuit (ASIC), a field-programmable gate array (FPGA), or the like.

The high-speed arithmetic device 205 may be omitted depending on the speed of necessary arithmetic processing.

The communication interface 206 is used as an interface for connecting to an external device so as to be able to communicate with the external device. Thus, the information processing device 200 can communicate with an external device such as the shovel 100 through the communication interface 206. The communication interface 206 may include a plurality of types of communication interfaces depending on a communication system with a device to be connected.

The input device 207 receives various inputs from a user.

The input device 207 includes, for example, an operation input device that receives a mechanical operation input from a user. The operation input device includes, for example, a button, a toggle, a lever, and the like. The operation input device includes, for example, a touch panel mounted on the display device 208, a touch pad provided separately from the display device 208, and the like.

The input device 207 includes, for example, a voice input device capable of receiving a voice input from the user. The voice input device includes, for example, a microphone capable of collecting a voice of the user.

The input device 207 includes, for example, a gesture input device capable of receiving a gesture input from the user. The gesture input device includes, for example, a camera capable of capturing an image of a gesture of the user.

The input device 207 includes, for example, a biometric input device capable of receiving a biometric input from the user. The biometric input device includes, for example, a camera capable of acquiring image data containing information on a fingerprint or an iris of the user.

The display device 208 displays an information screen and an operation screen to the user. For example, the display device 208 includes the above-described remote operation display device. The display device 208 is, for example, a liquid crystal display or an organic electroluminescence (EL) display.

Note that the remote operation assistance device 300 may be implemented by any given hardware or a combination of any given hardware and software, and may have the same hardware configuration as the information processing device 200. For example, the remote operation assistance device 300 is mainly configured by a computer including circuitry including a CPU, a memory device, an auxiliary storage device, an interface device, an input device, and a display device, similarly to the information processing device 200 (FIG. 5). The memory device is, for example, an SRAM, a DRAM, or the like. The auxiliary storage device is, for example, an HDD, an SSD, an EEPROM, a flash memory, or the like. The interface device includes an external interface for connection to an external recording medium and a communication interface for communication with the outside such as the shovel 100. The input device includes, for example, a lever-type operation input device. Thus, the operator can perform an operation input relating to the actuator of the shovel 100 using the operation input device, and the remote operation assistance device 300 can transmit a signal corresponding to the operation input to the shovel 100 using the communication interface. Therefore, the operator can remotely operate the shovel 100 using the remote operation assistance device.

### [Functional Configuration of Operation Assistance Device]

Next, a functional configuration of an operation assistance device 150 mounted on the shovel 100 will be described with reference to FIGS. 6 to 8, in addition to FIGS. 1 to 5.

### First Example

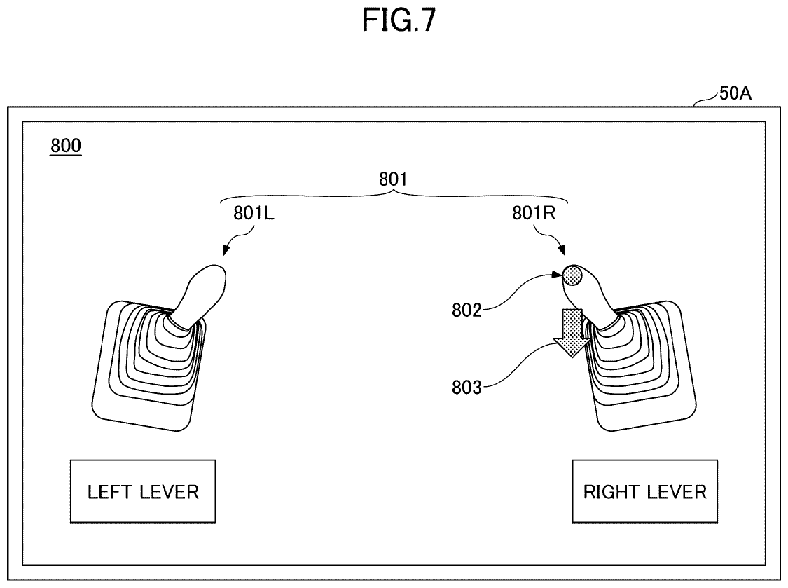

FIG. 6 is a block diagram illustrating a first example of a functional configuration of the operation assistance device 150. FIG. 7 is a diagram illustrating an example of a screen (operation instruction notification screen 800) displayed on the display device 50A to notify instructions relating to an operation of the shovel 100 (hereinafter, “operation instruction notification screen”).

The operation assistance device 150 assists the operation of the shovel 100 by an operator OP boarding the cabin 10.

As illustrated in FIG. 6, the operation assistance device 150 includes the operation device 26, the controller 30, the imaging device 40, the output device 50, and the communication device 60.

The controller 30 includes an operation instruction receiving unit 3001 and an operation instruction notification unit 3002 as functional units.

The operation instruction receiving unit 3001 receives instructions relating to the operation of the shovel 100 from outside the shovel 100. The instructions relating to the operation of the shovel 100 include, for example, an instruction for specifying a driven element to be operated and operating the driven element in a specific direction (hereinafter, “operation instruction by specifying a driven element” for convenience). The operation instruction by specifying a driven element includes, for example, an instruction to operate the boom 4 in a raising direction or a lowering direction, an instruction to operate the upper turning body 3 in a left turning direction or a right turning direction, and the like. The instruction relating to the operation of the shovel 100 includes an instruction of an operation for specifying a predetermined movement of the shovel 100 included in a predetermined work and causing the shovel 100 to perform the predetermined movement (hereinafter, for convenience, “operation instruction by specifying movement”). The predetermined work includes, for example, work implemented by a combination of a series of movements of a plurality of shovels 100 such as crane work. The crane work is configured by, for example, a movement of lifting a hoisting load, a movement of horizontally moving the hoisting load, a movement of lowering the hoisting load, a movement of stopping moving of the hoisting load, and the like as the predetermined movement. The horizontal movement of the hoisting load includes a horizontal movement of the hoisting load by traveling the lower traveling body 1 and a horizontal movement of the hoisting load by turning the upper turning body 3. The instruction relating to the operation of the shovel includes an instruction to adjust a movement speed of the driven element, the movement speed of the hoisting load, or the like according to the current operation (hereinafter, referred to as a “speed adjustment instruction” for convenience). The speed adjustment instruction includes, for example, an instruction to increase the speed and an instruction to decrease the speed. Further, each of the instruction to increase the speed and the instruction to decrease the speed may include an instruction to specify an increase range or a decrease range of the speed. The instruction relating to the operation of the shovel 100 includes an instruction relating to a procedure (setup) of work performed by operating the shovel 100 (hereinafter, referred to as a “work procedure instruction”). The work procedure instructions include an instruction indicating the order of movements for work for which the order of movements or the like is not determined, an instruction indicating the order of work items when a plurality of work items are continuously performed, and the like.

For example, the operation instruction receiving unit 3001 receives an instruction relating to the operation of the shovel 100 from a person around the shovel 100 (hereinafter, referred to as an “instructor” for convenience). The instructor is, for example, a worker who performs the same work in cooperation, a supervisor who supervises the work of the shovel 100, or a manager who manages the work site of the shovel 100.

Specifically, the operation instruction receiving unit 3001 may recognize a gesture representing an instruction relating to the operation of the shovel 100, which is performed by an instructor around the shovel 100, by using a known image recognition technology or the like on the basis of the captured image (moving image) of the imaging device 40. Thus, the operation instruction receiving unit 3001 can receive the instruction relating to the operation of the shovel 100 corresponding to the recognized gesture.

The gestures representing instructions relating to operations of the shovel 100 are defined in advance for on a per instruction content basis, and information on the gestures are registered in advance on a per instruction content basis in the auxiliary storage device 30A or the like. For example, in the case of an operation instruction with a driven element being specified, different gestures are defined in advance on a per instruction content basis such as an operation in the raising direction of the boom 4, an operation in the lowering direction of the boom 4, an operation in the left turning direction of the upper turning body 3, and an operation in the right turning direction of the upper turning body 3. For example, in the case of operation instructions relating to crane work, gestures are defined in advance on a per instruction content basis such as a movement of lifting a hoisting load, a movement of horizontally moving the hoisting load, a movement of lowering the hoisting load, a movement of stopping moving of the hoisting load, and a movement of slightly moving the hoisting load. The gesture for defining the operation of slightly moving the hoisting load may include an instruction content for specifying an operation direction and an operation amount. For example, in the case of the speed adjustment instruction, gestures are defined in advance on a per instruction content basis such as an instruction to increase a speed, an instruction to decrease a speed, and the like. The gesture for defining the instruction to increase a speed or the instruction to decrease a speed may include a gesture for defining the increase range or the decrease range of the speed. Further, for example, in the case of the work procedure instruction, a gesture is defined in advance on a per plurality of operations basis or on a per plurality of work items basis, and the work procedure instruction is implemented by combining these gestures.

The operation instruction receiving unit 3001 may recognize a gesture of an instructor around the shovel 100 based on the output of the distance sensor.

The operation instruction receiving unit 3001 may receive an instruction relating to the operation of the shovel 100 based on a signal (hereinafter, referred to as an “instruction signal”) including an instruction relating to the operation of the shovel 100, which is received from the information processing device 200 carried by an instructor around the shovel 100. In this case, the information processing device 200 transmits, in response to an input from the instructor through the input device 207, the instruction signal including the content of the instruction relating to the operation of the shovel 100 specified by the input, and the shovel 100 receives the instruction signal through the communication device 60. Thus, the instructor around the shovel 100 can issue an instruction relating to the operation of the shovel 100 to the shovel 100 (operator OP) using the information processing device 200.

The operation instruction receiving unit 3001 receives an instruction relating to the operation of the shovel 100 from a monitoring person who remotely monitors the work of the shovel 100 through the information processing device 200. For example, in the case of crane work, the worker or the like at the work site needs to be away from the crane to some extent, and thus there may be a situation in which the monitoring person can give an instruction relating to the operation of the shovel 100 while more appropriately grasping the situation of the hoisting load.

Specifically, the operation instruction receiving unit 3001 may receive the instruction relating to the operation of the shovel 100 based on a signal (instruction signal) including the instruction relating to the operation of the shovel 100, which is received from the information processing device 200 used by the monitoring person. In this case, the information processing device 200 transmits an instruction signal including the content of the instruction relating to the operation of the shovel 100 specified by the input in response to the input from the instructor through the input device 207, and the shovel 100 receives the instruction signal through the communication device 60. Thus, the instructor around the shovel 100 can give an instruction relating to the operation of the shovel 100 to the shovel 100 (operator OP) using the information processing device 200.

The operation instruction notification unit 3002 notifies the operator OP of the shovel 100 of the instruction relating to the operation of the shovel 100, which is received by the operation instruction receiving unit 3001, through the output device 50. The operation instruction notification unit 3002 may perform notification in a visual manner through the display device 50A or the like, may perform notification in an auditory manner through the sound output device 50B, or may perform notification in both the visual and auditory manners.

For example, the operation instruction notification unit 3002 notifies the operator of the content of the instruction relating to the operation of the shovel 100 as it is, through the output device 50.

The operation instruction notification unit 3002 may notify of the operator of the operation method of the operation device 26 according to the content of the instruction relating to the operation of the shovel 100 through the output device 50 (see FIG. 7). Thus, since the specific operation method of the operation device 26 is provided by notification, for example, even when the operator OP who has relatively little experience in operating the shovel 100 performs the operation, the operator OP can easily grasp the content of the instruction relating to the operation of the shovel 100.

As illustrated in FIG. 7, an image 801 simulating a lever device included in the operation device 26 is displayed on the operation instruction notification screen 800. The image 801 includes an image 801L that simulates an operation lever on the left side of an operator's seat and an image 801R that simulates the operation lever on the right side of the operator's seat. The operation lever on the left side of the operator's seat is used, for example, to operate the arm 5 by an operation in the front-rear direction and to perform a turning operation of the upper turning body 3 by an operation in the left-right direction. An operation lever on the right side of the operator's seat is used, for example, to raise and lower the boom 4 by an operation in the front-rear direction and to open and close the bucket 6 by an operation in the left-right direction.

In the present example, a marker image 802 indicating the operation target is displayed superimposed on the image 801R of the operation lever on the right side of the operator's seat. Thus, the operator OP can easily recognize that the right operation lever is the operation target.

In this example, a downward arrow image 803 direction is displayed in indicating the operation association with the image 801R of the operation lever at the operator's seat. Thus, the operator OP can easily recognize that an instruction to operate the right operation lever in the downward direction (that is, an instruction to lower the boom 4) is given.

The operation instruction notification unit 3002 may notify the operation method of the operation device 26 according to the content of the instruction relating to the operation of the shovel 100 using an illumination device (indicator lamp) attached to the operation device 26 instead of or in addition to the display device 50A. For example, an indicator lamp indicating an operation target and an indicator lamp indicating an operation direction are mounted on the operation lever on the left side of the operator's seat and the operation lever on the right side of the operator's seat.

In this way, in the present example, the controller 30 can notify the operator OP of an instruction relating to the operation of the shovel 100 from the outside of the shovel 100 through the output device 50. Therefore, the operator OP can more appropriately operate the shovel 100 after checking the instruction from the outside of the shovel 100.

In the present example, the shovel 100 (controller 30) receives an instruction relating to the operation of the shovel 100, and the operator OP recognizes the received instruction relating to the operation of the shovel 100 and then performs the operation. Therefore, the shovel 100 moves after the instruction is double checked by the shovel 100 and the operator OP, in response to the instruction from the outside of the shovel 100, and thus the shovel 100 can move more appropriately.

### Second Example

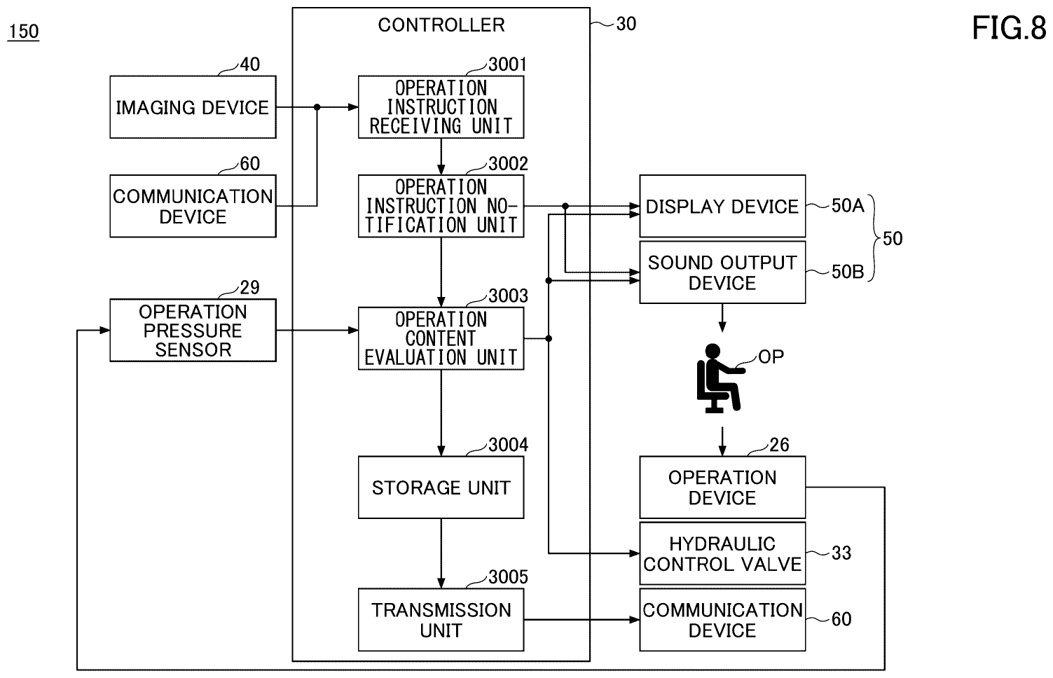

FIG. 8 is a functional block diagram illustrating a second example of a functional configuration of the operation assistance device 150.

The following description will be given focusing on differences from the first example (FIG. 6) described above, and the description of the same or corresponding contents as those in the first example described above may be omitted.

In FIG. 8, for convenience, the communication device 60 representing a function of receiving a signal from the information processing device 200 and the communication device 60 representing the function of transmitting a signal to the information processing device 200 are separately depicted.

As illustrated in FIG. 8, the operation assistance device 150 includes a controller 30, an imaging device 40, an output device 50, and a hydraulic control valve 33.

The controller 30 includes, as functional units, the operation instruction receiving unit 3001, the operation instruction notification unit 3002, an operation content evaluation unit 3003, a storage unit 3004, and a transmission unit 3005.

The operation content evaluation unit 3003 evaluates the content of the actual operation by the operator with respect to the content of the instruction relating to the operation of the shovel 100, which is received by the operation instruction receiving unit 3001 and provided by notification by the operation instruction notification unit 3002.

For example, the operation content evaluation unit 3003 evaluates whether or not there is a discrepancy between the content of the instruction relating to the operation of the shovel 100 and the content of the actual operation input to the operation device 26 by the operator OP after the notification of the operation instruction notification unit 3002. Then, when there is a discrepancy between the content of the instruction relating to the operation of the shovel 100 and the content of the actual operation input to the operation device 26 by the operator OP, the operation content evaluation unit 3003 may report the discrepancy to a user through the output device 50. The operation content evaluation unit 3003 may report the discrepancy in a visual manner through the display device 50A or the like, may perform notification in an auditory manner through the sound output device 50B, or may perform notification in both visual and auditory manners. Thus, for example, it is possible to warn the operator OP that the operation performed by the operator OP is different from the instruction relating to the operation of the shovel 100 from the outside of the shovel 100.

Further, when there is a discrepancy between the content of the instruction relating to the operation of the shovel 100 and the content of the actual operation input to the operation device 26 by the operator OP, the operation content evaluation unit 3003 may control the hydraulic control valve 33 to restrict the movement of the shovel 100. The movement restriction of the shovel 100 includes, for example, stopping of the operation of the shovel 100 in which the driven element is stopped and maintained in a stopped state without depending on the operation by the operator. The movement restriction of the shovel 100 may include, for example, deceleration of the movement of the shovel 100 in which the movement of the driven element with respect to the operation by the operator is made slower than usual. The driven elements subject to the movement restriction of the shovel 100 may be all the driven elements or may be only some of the driven elements including the driven elements to be moved by the actual operation input to the operation device 26 by the operator OP. Thus, even when the operator OP performs an operation different from the content of the instruction relating to the operation of the shovel 100, the movement of the shovel 100 can be restricted and the safety of the shovel 100 can be improved.

In addition, when there is a discrepancy between the content of the instruction relating to the operation of the shovel 100 and the content of the actual operation input to the operation device 26 by the operator OP, the operation content evaluation unit 3003 may record a log representing the presence of the discrepancy in the storage unit 3004. The log includes, for example, information representing a date and time when a discrepancy occurs between the content of the instruction relating to the operation of the shovel 100 and the content of the actual operation input to the operation device 26 by the operator OP, and information indicating that the discrepancy occurred. The log may include the content of the instruction relating to the operation of the shovel 100 and the content of the actual operation input to the operation device 26 by the operator OP. The log may include data relating to the activation state of the shovel 100 when a discrepancy occurs between the content of the instruction relating to the operation of the shovel 100 and the content of the actual operation input to the operation device 26 by the operator OP. The data relating to the activation state of the shovel 100 includes, for example, image data of the imaging device 40. Thus, for example, the log accumulated in the storage unit 3004 can be analyzed and used for evaluation relating to the instruction of the instructor, evaluation relating to the operation by the operator, evaluation relating to the work of the shovel 100, and the like.

The storage unit 3004 stores the data of the log.

Note that the log data in the storage unit 3004 may be deleted at a predetermined timing after being uploaded to the information processing device 200 by the transmission unit 3005 to be described later.

The transmission unit 3005 transmits (uploads) the data of the log in the storage unit 3004 to the information processing device 200.

For example, the transmission unit 3005 automatically transmits the untransmitted part of the log in the storage unit 3004 to the information processing device 200 at a predetermined timing. The predetermined timing is, for example, a timing at which the activation of the shovel 100 is stopped (that is, a timing at which the key switch is turned off), a timing at which the activation of the shovel 100 is started (that is, a timing at which the key switch is turned on), or the like.

The transmission unit 3005 may transmit the untransmitted log data in the storage unit 3004 to the information processing device 200, in response to a signal for requesting transmission of log data, which is received from the information processing device 200 through the communication device 60.

In this way, in the present example, the controller 30 can evaluate the discrepancy between the content of the instruction relating to the operation of the shovel 100 and the content of the operation input of the operator OP. Therefore, in a situation where the operation by the operator OP is different from the instruction, it is possible to issue a warning to the operator OP or restrict the movement of the shovel 100, and to improve the safety of the shovel 100.

### [Other Examples of Activation Assistance System]

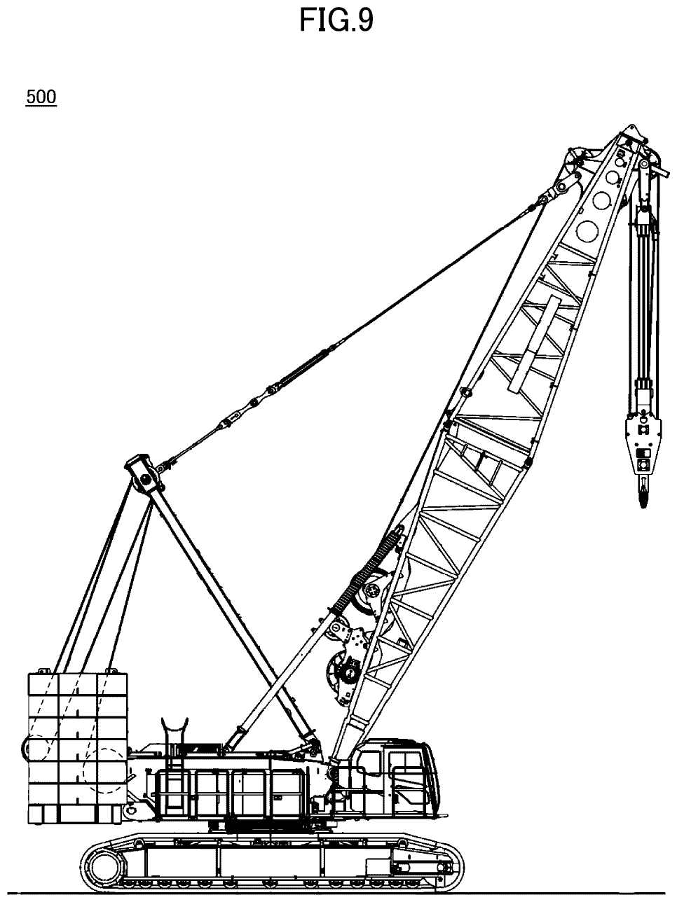

Next, another example of the activation assistance system SYS will be described with reference to FIG. 9.

FIG. 9 is a diagram illustrating another example of a work machine. Specifically, FIG. 9 is a side view illustrating an example of a crawler crane 500.

The embodiments relating to the activation assistance system SYS described above may be combined with each other, or may be modified or changed as appropriate.

For example, in the above-described embodiments, the operation assistance device 150 may perform operation assistance for an operator who performs remote operation of the shovel 100 using the remote operation assistance device 300. In this case, the operation instruction notification unit 3002 of the operation assistance device 150 transmits data relating to notification of an instruction for performing the operation of the shovel 100 to the remote operation assistance device 300 through the communication device 60. Thus, the remote operation assistance device 300 can notify the operator who performs remote operation of an instruction for performing the operation of the shovel 100 using the display device or the sound output device based on the data received from the shovel 100.

In the embodiment and the modifications of the embodiment described above, the remote operation assistance device 300 may be provided with the same function as the operation assistance device 150 (hereinafter, for convenience, “operation assistance device for remote operation”). That is, some or all of the functions of the controller 30 relating to the operation assistance device 150 may be transferred to the remote operation assistance device 300. In this case, the operation assistance device for remote operation includes an operation device for remote operation included in the input device of the remote operation assistance device 300, instead of the operation device 26.

Specifically, the function of the operation instruction notification unit 3002 may be transferred to the remote operation assistance device 300. Thus, the remote operation assistance device 300 can notify an operator who performs remote operation of an instruction for performing the operation of the shovel 100 through the display device or the like. Therefore, the operator of the remote operation can perform an operation input to the input device (operation device for remote operation) of the remote operation assistance device 300 and operate the shovel 100 while checking the notification. In this case, data representing the instruction relating to the operation of the shovel 100 from an instructor around the shovel 100, which is received by the operation instruction receiving unit 3001, is transmitted from the shovel 100 to the information processing device 200 through the communication device 60.

In addition to the function of the operation instruction notification unit 3002 of the operation assistance device 150, the function of the operation instruction receiving unit 3001 may be transferred to the remote operation assistance device 300. In this case, the data of the imaging device 40 is transmitted (uploaded) from the shovel 100 to the remote operation assistance device 300 through the communication device 60. Thus, the assistance device for remote operation can recognize the gesture of the instructor around the shovel 100 and receive an instruction relating to the operation of the shovel 100. In this case, the instruction signal from the information processing device 200 used by the instructor may be transmitted to the remote operation assistance device 300 via the shovel 100, or may be directly transmitted from the information processing device 200 to the remote operation assistance device 300.

Similarly, in addition to the function of the operation instruction notification unit 3002 of the operation assistance device 150, the functions of the operation content evaluation unit 3003, the storage unit 3004, and the transmission unit 3005 may be transferred to the remote operation assistance device 300.

In the above-described embodiment and the modifications of the embodiment, the portable information processing device 200 brought by the operator into the cabin 10 of the shovel 100 may be provided with the same functions as the operation assistance device 150 (hereinafter, referred to as “portable operation assistance device” for convenience). That is, a part or all of the functions of the controller 30 relating to the operation assistance device 150 may be transferred to the information processing device 200.

Specifically, the function of the operation instruction notification unit 3002 may be transferred to the portable information processing device 200. Thus, the portable information processing device 200 can notify the operator of the remote operation of an instruction relating to the operation of the shovel 100 through the display device or the like. Therefore, the operator of the remote operation can perform an operation input to the input device (operation device for remote operation) of the portable information processing device 200 and can operate the shovel 100 while checking the notification. In this case, data representing an instruction relating to the operation of the shovel 100 from an instructor around the shovel 100, which is received by the operation instruction receiving unit 3001, is transmitted from the shovel 100 to the information processing device 200 through the communication device 60.

In addition to the functions of the operation instruction notification unit 3002 of the operation assistance device 150, the functions of the operation instruction receiving unit 3001 may be transferred to the portable information processing device 200. In this case, the data of the imaging device 40 is transmitted (uploaded) from the shovel 100 to the portable information processing device 200 through the communication device 60. Thus, the assistance device for remote operation can recognize the gesture of the instructor around the shovel 100 and receive an instruction relating to the operation of the shovel 100. In this case, the instruction signal from the information processing device 200 used by the instructor may be transmitted to the portable information processing device 200 via the shovel 100, or may be directly transmitted from the information processing device 200 to the portable information processing device 200.

Similarly, in addition to the functions of the operation instruction notification unit 3002 of the operation assistance device 150, the functions of the operation content evaluation unit 3003, the storage unit 3004, and the transmission unit 3005 may be transferred to the portable information processing device 200.

The operation assistance device 150 according to the above-described embodiment or the modifications of the embodiment may receive an instruction relating to the operation of another work machine different from the shovel 100 and notify the user, that is, the operator of the work machine of the instruction relating to the operation of the work machine. For example, as illustrated in FIG. 9, another work machine is the crawler crane 500. In this case, the activation assistance system SYS includes another work machine such as the crawler crane 500 instead of or in addition to the shovel 100.

### [Effect]

Next, the operation of the activation assistance system SYS (operation assistance device) according to the present embodiment will be described.

For example, when an instruction is issued from the outside of the work machine to directly operate the work machine, a blind spot may exist around the work machine, such as a place deep inside the work machine, depending on the position of the person giving the instruction, and as a result, an appropriate operation according to the surrounding area of the work machine may not be performed. Further, for example, in a case where an instruction is issued from the outside of the work machine by an action of a person such as a gesture and the work machine is directly operated, there is a possibility that the movement of the work machine cannot be appropriately operated depending on the recognition accuracy or the like.

In contrast, in the present embodiment, the operation assistance device includes a receiving unit that receives an instruction relating to the operation of the work machine from the outside of the work machine, and a notification unit that notifies a user of the instruction relating to the operation of the work machine received by the receiving unit. The operation assistance device is, for example, the operation assistance device 150, an operation assistance device for remote operation, or a portable operation assistance device. The work machine is, for example, the shovel 100 or the crawler crane 500. The receiving unit is, for example, the operation instruction receiving unit 3001. The notification unit is, for example, the operation instruction notification unit 3002.

The operation assistance device may include an operation unit that receives an operation input by the user with respect to the work machine. The operation unit is, for example, the operation device 26 of the shovel 100 or an operation device for remote operation in the remote operation assistance device 300.

Thus, the operation assistance device recognizes the instruction content from the outside of the work machine, and the instruction content is notified to the user (operator), whereby the user recognizes the instruction content, and the work machine is operated by the user who has recognized the instruction content. Therefore, the content of the instruction relating to the operation of the work machine is double-checked by the operation assistance device and the operator. As a result, for example, when there is a problem in recognition of an instruction issued by the operation assistance device 150, the operator can be prevented from performing an operation according to the instruction content. For example, when an obstacle which goes unnoticed by the instructor around the shovel 100 is present and the operation according to the instruction content is not appropriate, the operation according to the instruction content can be prevented from being performed. Therefore, the operation assistance device can more appropriately operate the work machine in response to an instruction from the outside of the work machine.

In the present embodiment, the instruction relating to the operation of the work machine may include at least one of a first instruction for an operation of specifying a driven element of the work machine and operating the driven element in a specific direction, a second instruction for an operation of specifying a movement constituting a work item and executing the movement, a third instruction for an operation of adjusting a movement speed of the work machine, or a fourth instruction relating to a procedure of a plurality of movements or a procedure of a plurality of work items.

Thus, the operation assistance device can instruct the user to operate the specific driven element in the specific direction. The operation assistance device can instruct the user to perform an operation for performing a specific movement constituting the work. The operation assistance device can instruct the user to adjust the movement speed of the work machine. The operation assistance device can instruct the user to perform a procedure of a plurality of movements and a procedure of a plurality of work items.

In the present embodiment, the receiving unit may receive an instruction relating to an operation of the work machine from an instructor around the work machine.

Thus, the user can operate the work machine while checking the instruction from the instructor around the work machine.

In the present embodiment, the receiving unit may recognize a gesture representing an instruction relating to an operation of the work machine from the instructor, based on sensing information representing a surrounding area of the work machine, and may receive the instruction relating to the operation of the work machine.

Thus, the instructor can give a gesture-based instruction to the user who operates the work machine.

In the present embodiment, the operation assistance device may further include a reporting unit that notifies the user that there is a discrepancy between the content of the instruction relating to the operation of the work machine provided by notification by the notification unit and the content of the subsequent actual operation input to the work machine. The reporting unit is, for example, the operation content evaluation unit 3003.

Thus, the operation assistance device can warn the user that there is a discrepancy in the content of the actual operation input to the work machine by the user with respect to the instruction relating to the operation of the work machine, for example.

In the present embodiment, the operation assistance device may further include a recording unit that records, when there is a discrepancy between the content of the instruction relating to the operation of the work machine provided by notification by the notification unit and the content of the subsequent actual operation input to the work machine, a log representing the discrepancy in a predetermined storage unit. The recording unit is, for example, the operation content evaluation unit 3003.

Thus, the operation assistance device can analyze the log, and perform evaluation relating to the instruction of the instructor, evaluation relating to the operation by the operator, evaluation relating to the work of the work machine, and the like.

In the present embodiment, the work machine may include the above-described operation assistance device.

Thus, the work machine can notify a user, such as an operator boarding the work machine or an operator performing remote operation, of an instruction from the outside of the work machine.

In the present embodiment, the remote operation assistance device may include the above-described operation assistance device. In this case, the operation unit may receive an operation input of a remote operation for the work machine. The remote operation assistance device is, for example, the remote operation assistance device 300. The operation unit is, for example, an operation device for remote operation.

Thus, the remote operation assistance device can notify the operator of the remote operation of an instruction from outside of the work machine.

### [Overview of Remote Operation System]

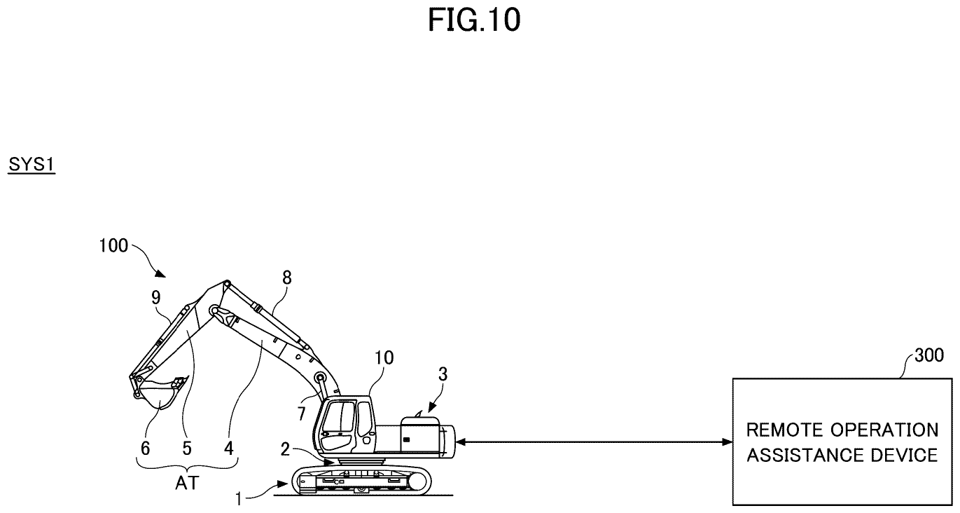

Next, an overview of a remote operation system SYS1 for the shovel 100 according to the present embodiment will be described with reference to FIG. 10.

Hereinafter, the shovel 100 will be described focusing on the parts different from the above-described activation assistance system SYS, and the description of the same or corresponding contents as those in the case of the activation assistance system SYS may be omitted.

FIG. 10 is a diagram illustrating an example of the remote operation system SYS1 for the shovel 100. In FIG. 10, the shovel 100 is illustrated in a left side view.

The top view of the shovel 100 may be the same as FIG. 2 described above. Therefore, in the description of the remote operation system SYS1, the illustration of the top view of the shovel 100 is omitted, and the above-described FIG. 2 is used.

As illustrated in FIG. 10, the remote operation system SYS1 includes the shovel 100 and the remote operation assistance device 300.

The remote operation system SYS1 implements remote operation of the shovel 100 by a user using the remote operation assistance device 300. Hereinafter, a user who performs remote operation of the shovel 100 using the remote operation assistance device 300 may be referred to as an “operator of remote operation” for convenience.

The shovel 100 is a work machine to be remotely controlled.

Note that the target of remote operation in the remote operation system SYS1 may be another work machine different from the shovel 100. For example, the remote operation system SYS1 may include the crawler crane 500 as a target of remote operation (see FIG. 9 described above). The same may be applied to a work machine for which security is to be ensured in a security system SYS2 described later.

As illustrated in FIGS. 2 and 10, the shovel 100 includes a lower traveling body 1; an upper turning body 3; an attachment AT including a boom 4, an arm 5, and a bucket 6; and a cabin 10.

The lower traveling body 1 includes, for example, a left crawler 1CL and a right crawler 1CR, and travels by itself when the crawlers 1CL and 1CR are hydraulically driven by the corresponding traveling hydraulic motors 1M.

The upper turning body 3 is turnably mounted on the lower traveling body 1 via the turning mechanism 2. For example, the upper turning body 3 turns with respect to the lower traveling body 1 by the turning mechanism 2 being hydraulically driven by the turning hydraulic motor 2M.

The boom 4 is attached to the center of the front portion of the upper turning body 3 so as to be able to be raised and lowered about a rotation axis in the horizontal direction. The arm 5 is attached to the distal end of the boom 4 so as to be rotatable about a rotation axis in the left-right direction. The bucket 6 is attached to the distal end of the arm 5 so as to be rotatable about a rotation axis in the right-left direction.

The bucket 6 is an example of an end attachment, and is attached to the distal end of the arm 5 in a manner that allows the bucket 6 to be appropriately replaced according to the work content of the shovel 100. That is, instead of the bucket 6, a bucket of a type different from the bucket 6, for example, a relatively large bucket, a slope bucket, a dredging bucket, or the like may be attached to the distal end of the arm 5. Further, an end attachment of a type other than the bucket, for example, a stirrer, a breaker, a crusher, or the like may be attached to the distal end of the arm 5. Further, for example, an auxiliary attachment such as a quick coupling or a tilt rotator may be provided between the arm 5 and the end attachment.

The boom 4, the arm 5, and the bucket 6 are hydraulically driven by a boom cylinder 7, an arm cylinder 8, and a bucket cylinder 9, respectively.

The cabin 10 is a control room for an operator to board and operate the shovel 100, and is mounted on, for example, the front left side of the upper turning body 3.

As described above, the shovel 100 is configured to be remotely operated from the remote operation assistance device 300. Specifically, the shovel 100 operates the driven elements such as the lower traveling body 1 (that is, the pair of left and right crawlers 1C), the upper turning body 3, the boom 4, the arm 5, and the bucket 6 according to the operation content of the operator of the remote operation received from the remote operation assistance device 300. When the shovel 100 is remotely operated, the inside of the cabin 10 may be unmanned.

The shovel 100 may be configured to be capable of operating driven elements such as the lower traveling body 1 (that is, the pair of left and right crawlers 1C), the upper turning body 3, the boom 4, the arm 5, and the bucket 6 in response to an operation of an operator who boards the cabin 10. Hereinafter, the operation by the operator of the remote operation and the operation by the operator of the cabin 10 may be collectively referred to as “operation by the operator”.

Note that, when only the remote operation of the shovel 100 is possible, the cabin 10 may be omitted.

The remote operation assistance device 300 receives an input relating to an operation of the shovel 100 from a user (operator of the remote operation) and transmits a signal indicating the operation content (hereinafter, referred to as a “remote operation signal”) to the shovel 100, thereby assisting the remote operation of the shovel 100.

The remote operation assistance device 300 is, for example, a portable terminal device (that is, a mobile terminal) that can be carried by a user. Thus, in the work site of the shovel 100, the user can remotely operate the shovel 100 using the remote operation assistance device 300 while visually recognizing the shovel 100 and the place of the work target of the shovel 100.

The remote operation assistance device 300 may be a mobile terminal dedicated to remote operation of the shovel 100 or may be a general-purpose mobile terminal such as a smartphone or a tablet terminal. In the latter case, a dedicated application operable in coordination with the shovel 100 may be installed in advance.

### [Hardware Configuration of Remote Operation System]

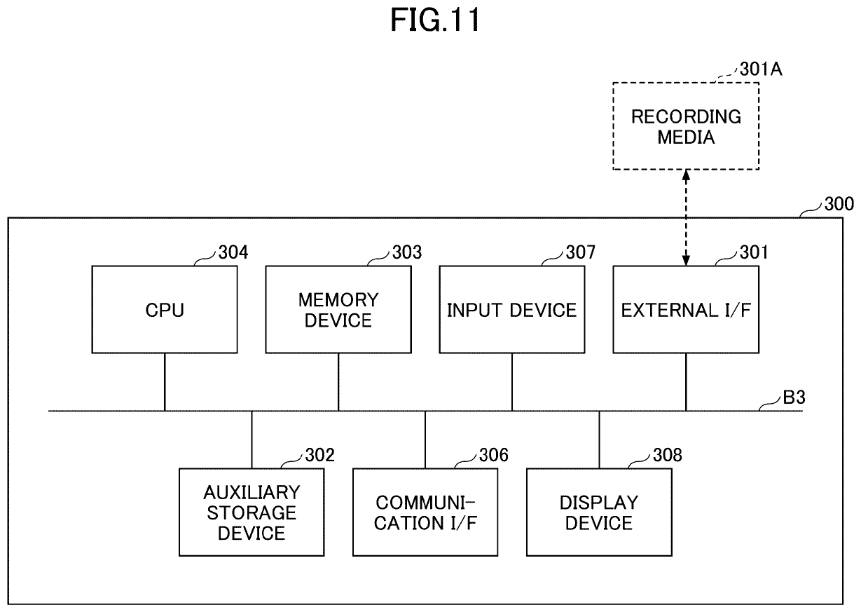

Next, a hardware configuration of the remote operation system SYS1 will be described with reference to FIG. 11 in addition to FIG. 10.

The hardware configuration of the shovel 100 may be the same as that of FIG. 4 described above. Therefore, illustration and description of the hardware configuration of the shovel 100 in the remote operation system SYS1 will be omitted.

### <Hardware Configuration of Remote Operation Assistance Device>

FIG. 11 is a diagram illustrating an example of a hardware configuration of the remote operation assistance device 300.

The functions of the remote operation assistance device 300 are implemented by any given hardware, a combination of any given hardware and software, or the like. For example, as illustrated in FIG. 11, the remote operation assistance device 300 includes an external interface 301, an auxiliary storage device 302, a memory device 303, a CPU 304, a communication interface 306, an input device 307, and a display device 308, which are connected by a bus B2.

The external interface 301 functions as an interface for reading from a recording media 301A and writing to the recording media 301A. The recording media 301A include, for example, flexible disks, CDs (Compact Discs), DVDs (Digital Versatile Discs), BD (Blu-ray (trademark) Disc), SD memory cards, USB-type memories, and the like. The remote operation assistance device 300 can read various kinds of information used in processing and store the information in the auxiliary storage device 302, and can install programs for implementing various functions, through the recording media 301A.

The remote operation assistance device 300 may acquire various data and programs from an external device via the communication interface 306.

The auxiliary storage device 302 stores the installed various programs, and also stores files, data, and the like necessary for the various processes. The auxiliary storage device 302 includes, for example, a hard disk drive (HDD), a solid state drive (SSD), a flash memory, or the like.

When an instruction to activate a program is issued, the memory device 303 reads the program from the auxiliary storage device 302 and stores the program. The memory device 303 includes, for example, a dynamic random access memory (DRAM) or an SRAM.

The CPU 304 executes various programs loaded from the auxiliary storage device 302 to the memory device 303, and implements various functions relating to the remote operation assistance device 300 according to the programs.

The communication interface 306 is used as an interface for connecting to an external device so as to be able to communicate with the external device. Thus, the remote operation assistance device 300 can communicate with an external device such as the shovel 100 through the communication interface 306. The communication interface 306 may include a plurality of types of communication interfaces depending on a communication system with a device to be connected.

The input device 307 receives various inputs from a user. For example, the input device 307 includes an input device for an operator to perform remote operation, that is, an operation device for remote operation.

The input device 307 includes, for example, an operation input device that receives a mechanical operation input from a user. The operation input device includes, for example, a button, a toggle, a lever, and the like. The operation input device includes, for example, a touch panel mounted on the display device 208, a touch pad provided separately from the display device 208, and the like.

The input device 307 includes, for example, a voice input device capable of receiving a voice input from the user. The voice input device includes, for example, a microphone capable of collecting a voice of the user.

The input device 307 includes, for example, a gesture input device capable of receiving a gesture input from the user. The gesture input device includes, for example, a camera capable of capturing an image of a gesture of the user.

The input device 307 includes, for example, a biometric input device capable of receiving a biometric input from the user. The biometric input device includes, for example, a camera capable of acquiring image data containing information on a fingerprint or an iris of the user.

The display device 208 displays an information screen and an operation screen to the user. For example, the display device 208 includes the above-described remote operation display device. The display device 208 is, for example, a liquid crystal display or an organic electroluminescence (EL) display.

### [Functional Configuration of Shovel Surrounding Monitoring Function]

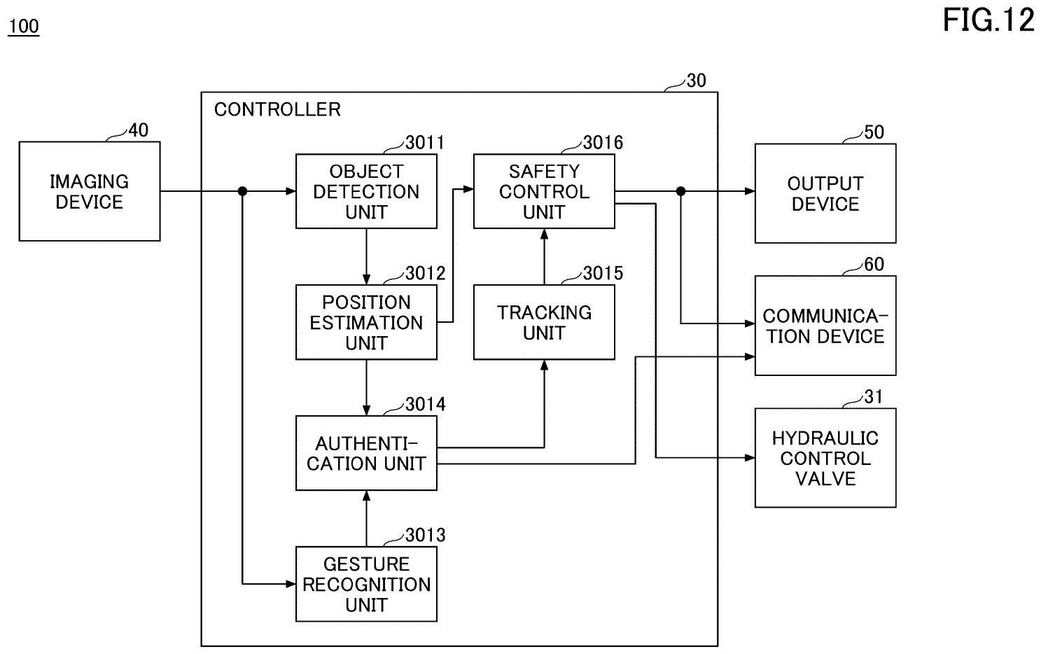

Next, a functional configuration relating to the surrounding monitoring function of the shovel 100 will be described with reference to FIG. 12.

FIG. 12 is a block diagram illustrating an example of a functional configuration relating to a surrounding monitoring function of the shovel 100.

The controller 30 includes an object detection unit 3011, a position estimation unit 3012, a gesture recognition unit 3013, an authentication unit 3014, a tracking unit 3015, and a safety control unit 3016.

The object detection unit 3011 detects an obstacle (hereinafter, simply referred to as a “monitoring object”) to be monitored around the shovel 100. Specifically, the object detection unit 3011 may perform a process for detecting the monitoring object around the shovel 100 at predetermined processing cycles. The monitoring object includes, for example, a person such as a worker. The monitoring object may include, for example, another work machine, a work vehicle, or the like. The monitored objects may include, for example, certain stationary objects in the work site, such as utility poles, fences, triangular cones, etc. The monitoring objects may include a specific topographical shape of the work site such as a ditch or a hole.

The object detection unit 3011 detects a monitoring object around the shovel 100 using a known method, for example, based on output data (captured image) of the imaging device 40 (an example of a second sensor) or the distance sensor (an example of a second sensor) of the shovel 100. In addition, when both the imaging device 40 and the distance sensor are mounted on the shovel 100, the object detection unit 3011 may detect an object around the shovel 100 by applying a sensor fusion technique to output data of the imaging device 40 and the distance sensor.

The position estimation unit 3012 estimates a position (hereinafter, “actual position”) at which the monitoring object detected by the object detection unit 3011 actually exists when viewed from the shovel 100. Specifically, when the monitoring object is detected by the object detection unit 3011, the position estimation unit 3012 may perform a process of estimating the actual position of the monitoring object. When a plurality of monitoring objects are detected by the object detection unit 3011, the position estimation unit 3012 may estimate the actual position of each of the plurality of monitoring objects.

For example, the position estimation unit 3012 specifies the actual position of the detected monitoring object based on a position and size of a partial region corresponding to the detected monitoring object in an image of the camera 40X. In addition, when the camera 40X is a 3D camera, the position estimation unit 3012 may estimate the actual position of the detected monitoring object based on coordinate information of the partial region (pixel group) corresponding to the detected monitoring object in the image of the camera 40X with respect to the shovel (shovel 100). In addition, when both the camera 40X and the distance sensor are mounted on the shovel 100, the position estimation unit 3012 may estimate the actual position of the detected monitoring object in a manner similar to that of a 3D camera by applying a sensor fusion technique to the output data of the camera 40X and the distance sensor. The position estimation unit 3012 may estimate the actual position of the detected monitoring object based on coordinate information of a portion of the detected monitoring object in three dimensional data of an object around the shovel (shovel 100) generated from output data of the distance sensor.

The gesture recognition unit 3013 (an example of a recognition unit) recognizes a predetermined gesture performed by a person around the shovel 100 based on the output data of the imaging device 40 (an example of a first sensor). The gesture recognition unit 3013 may recognize a predetermined gesture performed by a person around the shovel 100 on the basis of output data (e.g., point group data) of a distance sensor (an example of a first sensor). The predetermined gesture includes, for example, a predetermined body movement or hand movement. The predetermined gesture may include all the human actions such as movement of a person.

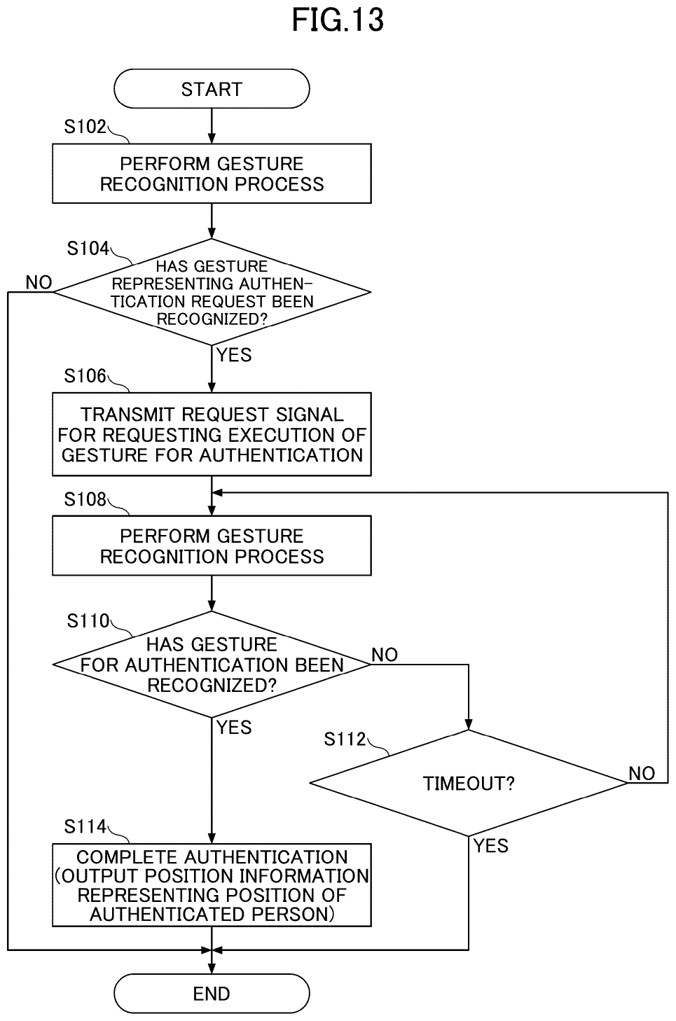

The authentication unit 3014 authenticates a specific person around the shovel 100. The specific person is, for example, an operator who remotely operates the shovel 100 using the remote operation assistance device 300 around the shovel 100, and a manager or a supervisor at the work site of the shovel 100, or the like. Thus, the controller 30 can perform control relating to the surrounding monitoring function by distinguishing between the authenticated specific person and other persons among persons around the shovel 100 (see FIG. 13).

Specifically, when a predetermined gesture is recognized by the gesture recognition unit 3013, the authentication unit 3014 performs authentication of a person who performs the predetermined gesture. The authentication unit 3014 estimates the actual position of the person who performs the predetermined gesture by the same method as that of the position estimation unit 3012, and outputs the position information of the authenticated person. Details will be described later (see FIG. 13).

The tracking unit 3015 tracks the actual position of the person authenticated by the authentication unit 3014. Thus, the controller 30 can distinguish the person authenticated by the authentication unit 3014 from the persons detected by the object detection unit 3011.

For example, when the authentication of the specific person is completed by the authentication unit 3014, the tracking unit 3015 compares the position information of the person authenticated by the authentication unit 3014 with the position information of the object around the shovel 100 estimated by the position estimation unit 3012 and the types of the objects. The tracking unit 3015 specifies an authenticated person from among the objects detected by the object detection unit 3011 based on the comparison result. Then, the tracking unit 3015 tracks the actual position of the person authenticated by the authentication unit 3014 based on the detection result by the object detection unit 3011 and the estimation result by the position estimation unit 3012 for each predetermined processing cycle.

The safety control unit 3016 (an example of a first control unit) performs control relating to functional safety of the shovel 100.

For example, the safety control unit 3016 activates the safety function when the object detection unit 3011 detects a monitoring object within a predetermined range around the shovel 100. Specifically, the safety control unit 3016 may activate the safety function when the actual position of the monitoring object specified by the position estimation unit 3012 is within the predetermined range around the shovel 100.

The safety function may include, for example, a reporting function of outputting an alarm or the like to at least one of the inside of the cabin 10, the outside of the cabin 10, or a remote operator of the shovel 100 to notify an operator and the like of the detection of the monitoring object. This enables an operator inside the cabin 10, workers around the shovel 100, and a remote operator who performs the remote operation of the shovel 100 to be alerted to the presence of the monitoring object within a monitoring area around the shovel 100. Hereinafter, a reporting function to the inside of cabin 10 (e.g., operator), a reporting function to the outside of the shovel 100 (e.g., operator), and a reporting function to an operator who operates the shovel 100 remotely may be referred to and distinguished as the “internal reporting function,” the “external reporting function,” and the “remote reporting function,” respectively.

The safety function may include, for example, a movement restriction function of restricting the movement of the shovel 100 with respect to the operation of the operation device 26 or the remote operation. Thus, the movement of the shovel 100 is forcibly restricted, and the possibility of the approach, contact, or the like between the shovel 100 and a surrounding object can be reduced. The movement restriction function may include a movement speed reducing function of reducing the movement speed of the shovel 100 to be lower than normal with respect to the operation of the operation device 26 or the remote operation. The movement restriction function may include a movement stopping function of stopping the movement of the shovel 100 and maintaining the stopped state regardless of the presence or absence of the operation of the operation device 26 or the remote operation.

For example, when the object detection unit 3011 detects a monitoring object in a predetermined range (hereinafter, referred to as a “reporting range”) around the shovel 100, the safety control unit 3016 activates the reporting function. The reporting range is, for example, a range in which the distance D from a predetermined part of the shovel 100 is equal to or less than the threshold Dth1. The predetermined part of the shovel 100 is, for example, the upper turning body 3. The predetermined part of the shovel 100 may be, for example, the bucket 6 or a hook at the distal end of the attachment AT. The threshold Dth1 may be constant regardless of the direction viewed from the predetermined part of the shovel 100 or may vary depending on the direction viewed from the predetermined part of the shovel 100.

The safety control unit 3016 activates an internal reporting function or an external reporting function by sound (that is, an auditory method) for at least one of the inside or the outside of the cabin 10 by controlling the output device 50 (sound output device), for example. At this time, the safety control unit 3016 may change the pitch, the sound pressure, and the tone of the sound to be output, the sound-triggering cycle in a case where the sound is periodically triggered, the content of the voice, and the like, according to various conditions.

The safety control unit 3016 activates an internal reporting function in a visual manner, for example. Specifically, the safety control unit 3016 may control the output device 50 (display device) inside the cabin 10 to display an image indicating that the monitoring object is detected together with the surrounding image on the output device 50. The safety control unit 3016 may highlight a monitoring object appearing in the surrounding image displayed on the output device 50 (display device) inside the cabin 10 or a position on the surrounding image corresponding to the detected monitoring object. More specifically, the safety control unit 3016 may superimpose and display a frame surrounding the detected monitoring object on the surrounding image displayed on the output device 50 inside the cabin 10, or may superimpose and display a marker at a position on the surrounding image corresponding to the actual position of the detected monitoring object. Thus, the output device 50 can implement a visual reporting function for the operator. The safety control unit 3016 may notify an operator or the like inside the cabin 10 that the monitoring object is detected using a warning lamp, an illumination device, or the like inside the cabin 10.

The safety control unit 3016 may activate the external reporting function in a visual manner by controlling the output device 50 (e.g., an illumination device such as a headlight or a display device) provided on the side surface of the house portion of the upper turning body 3, for example. The safety control unit 3016 may operate the external reporting function by transmitting an instruction signal indicating the operation of the reporting function to a terminal device (portable terminal) carried by a person around the shovel 100 such as a worker, a supervisor, or a manager at the work site. The terminal device carried by the worker, the supervisor, the manager, or the like at the work site is, for example, a general-purpose portable terminal such as a smartphone or a tablet terminal. The terminal device carried by the worker, the supervisor, the manager, or the like at the work site may be a wearable terminal. The wearable terminal is, for example, smart glasses. The safety control unit 3016 may activate the internal reporting function by a tactile method by controlling a vibration generation device that vibrates the operator's seat on which the operator sits, for example. Thus, the controller 30 can make the operator, the worker, the supervisor, and the like around the shovel 100 recognize that the monitoring object (e.g., a person such as the worker) is present at a relatively close place around the shovel 100. Therefore, the controller 30 can prompt the operator to check the safety surrounding area of the shovel 100, and can prompt the worker or the like in the monitoring area to evacuate from the monitoring area.

The safety control unit 3016 may operate the remote reporting function by transmitting an instruction signal indicating the operation of the reporting function to the remote operation assistance device 300 through the communication device 60, for example. In this case, when the remote operation assistance device 300 receives the instruction signal from the shovel 100, the remote operation assistance device 300 may output an alarm in a visual manner or an auditory manner. Accordingly, the operator who performs the remote operation of the shovel 100 can recognize that the monitoring object enters the reporting range around the shovel 100 by the warning by the remote reporting function through the remote operation assistance device 300 in addition to the warning by the external reporting function.

The remote reporting function of the safety control unit 3016 may be transferred to the remote operation assistance device 300. In this case, the remote operation assistance device 300 receives information on a detection situation of the monitoring object by the object detection unit 3011 and the specification result of the actual position of the monitoring object by the position estimation unit 3012 from the shovel 100. Then, the remote operation assistance device 300 determines whether or not the monitoring object enters the reporting range on the basis of the received information, and activates the remote reporting function when the monitoring object is present within the reporting range.

The safety control unit 3016 may change the notification mode (that is, the notification method) according to the positional relationship between the monitoring object detected within the reporting range and the upper turning body 3.

For example, when the monitoring object detected within the reporting range by the object detection unit 3011 is present at a position relatively far from a predetermined part of the shovel 100, the safety control unit 3016 may output an alarm (hereinafter, “caution level alarm”) of a relatively low urgency degree to the extent of drawing attention to the monitoring object. Hereinafter, a range of the reporting range in which the distance t the predetermined part of the shovel 100 is relatively long, that is, a range corresponding to the caution level alarm may be referred to as a “caution reporting range” for convenience. However, when the monitoring object detected within the reporting range by the object detection unit 3011 is present at a position relatively close to the predetermined part of the shovel 100, the safety control unit 3016 may output an alarm with a relatively high urgency degree (hereinafter, “warning level alarm”) for notifying that the monitoring object approaches the predetermined part of the shovel 100 and the degree of risk increases. Hereinafter, a range of the reporting range in which the distance to the predetermined part of the shovel 100 is relatively short, that is, a range corresponding to the warning level alarm may be referred to as a “warning reporting range”.

In this case, the safety control unit 3016 may make the pitch, sound pressure, tone, sound-triggering cycle, and the like of the sound output from the output device 50 (sound output device) different between the caution level alarm and the warning level alarm. The safety control unit 3016 may differentiate the color, shape, size, presence or absence of blinking, blinking cycle, and the like of an image indicating that the monitoring object displayed on the output device 50 (display device) is detected or an image (e.g., a frame or a marker) emphasizing the monitoring object or the position of the monitoring object on the surrounding image displayed on the output device 50 between the caution level alarm and the warning level alarm. Thus, the controller 30 can cause the operator or the like to grasp the degree of urgency, in other words, the degree of approach of the monitoring object to the predetermined part of the shovel 100, by the notification sound (alarm sound) output from the output device 50 or the difference in the notification image displayed on the output device 50.

The safety control unit 3016 may stop the reporting function when the monitoring object detected by the object detection unit 3011 is not detected within the reporting range after the start of the operation of the reporting function. The safety control unit 3016 may stop the reporting function when a predetermined input for canceling the operation of the reporting function is received through the input device 52 after the operation of the reporting function is started.

For example, when the object detection unit 3011 detects a monitoring object within a predetermined range (hereinafter, referred to as a “movement restriction range”) around the shovel 100, the safety control unit 3016 activates the movement restriction function. The movement restriction range is set to be the same as the reporting range described above, for example. Further, the movement restriction range may be set to a range in which the outer edge of the movement restriction range is relatively closer to a predetermined part of the shovel 100 than the reporting range, for example. Accordingly, for example, when the monitoring object enters the reporting range from the outside, the safety control unit 3016 can first activate the reporting function, and then, when the monitoring object enters the movement restriction range, the safety control unit 3016 can further activate the movement restriction function. Therefore, the controller 30 can activate the reporting function and the movement restriction function in a stepwise manner according to the movement of the monitoring object to the inside in the monitoring area.

Specifically, the safety control unit 3016 may activate the movement restriction function when the monitoring object is detected within the movement restriction range in which the distance D from the predetermined part of the shovel 100 is equal to or smaller than a threshold Dth2 (≤Dth1). The threshold Dth2 may be constant regardless of the direction viewed from the predetermined part of the shovel 100 or may vary depending on the direction viewed from the predetermined part of the shovel 100.

The movement restriction range includes at least one of a movement deceleration range in which the movement speed of the shovel 100 with respect to the operation of the operation device 26 or the remote operation is made slower than normal or a movement stop range in which the movement of the shovel 100 is stopped and the stopped state is maintained regardless of the presence or absence of the operation of the operation device 26 or the remote operation. For example, when both the movement deceleration range and the movement stop range are included in the movement restriction range, the movement stop range is a range close to a predetermined part of the shovel 100 in the movement restriction range. The movement deceleration range is a range set outside the movement stop range in the movement restriction range.

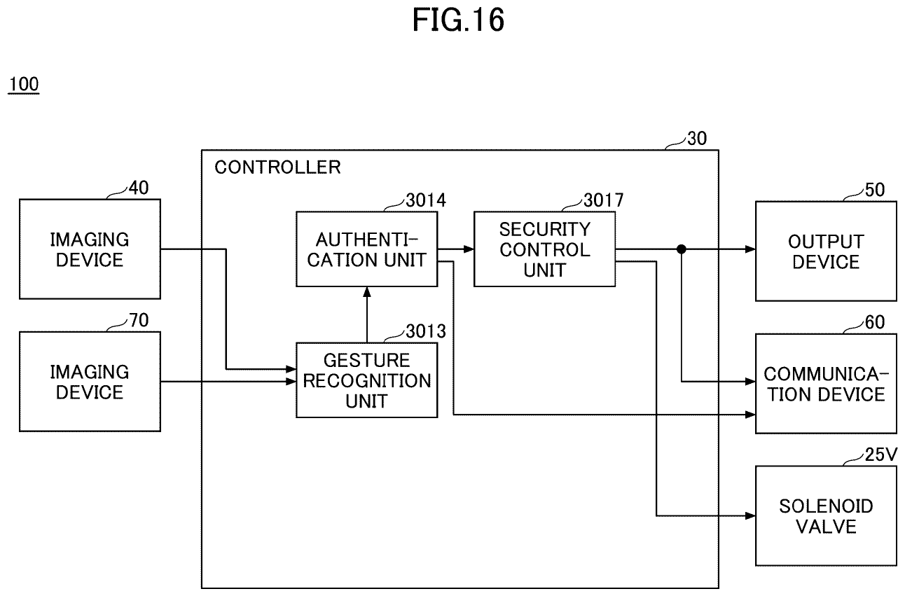

The safety control unit 3016 controls the hydraulic control valve 31 to activate a movement restriction function of restricting the movement of the shovel 100. In this case, the safety control unit 3016 may restrict the movement of all the driven elements (that is, the corresponding hydraulic actuators), or may restrict the movement of some of the driven elements (hydraulic actuators). Thus, the controller 30 can decelerate or stop the movement of the shovel 100 when the monitoring object is present around the shovel 100. Therefore, the controller 30 can prevent the occurrence of contact between the monitoring object around the shovel 100 and the shovel 100 or the hoisting load. The safety control unit 3016 may control a solenoid switching valve 25V (see FIG. 16) on the most upstream side of the pilot line 25 to shut off the pilot line 25, thereby activating the movement restriction function (movement stopping function).

Further, the safety control unit 3016 may stop the movement restriction function when the monitoring object detected by the object detection unit 3011 is not detected within the movement restriction range after the movement restriction function starts being activated. The safety control unit 3016 may stop the movement restriction function when a predetermined input for canceling the operation of the movement restriction function is received through the input device 52 after the activation of the movement restriction function is started. The content of the input for canceling the activation of the reporting function to the input device 52 and the content of the input for canceling the activation of the movement restriction function may be the same or different.

The safety control unit 3016 may perform different control on the activation of the safety function between a person who has been authenticated by the authentication unit 3014 and other objects among the objects detected by the object detection unit 3011.

For example, in the case of a person who has been authenticated by the authentication unit 3014, the safety control unit 3016 prohibits (cancels) the activation of the safety function, unlike the case of other objects. Thus, for example, the operator of the remote operation authenticated by the authentication unit 3014 can approach the shovel 100 and check the situation of the shovel 100, the situation of the ground surface subject to work by the shovel 100, and the like without considering the activation of the reporting function or the movement restriction function.

Note that, when the remote operation is temporarily stopped, the shovel 100 basically does not move. Therefore, even when the operator of the remote operation approaches the shovel 100 to some extent, the reduction in safety of the shovel 100 is limited.

The safety control unit 3016 may prohibit (cancel) only a part of the safety function.

For example, the safety control unit 3016 prohibits (cancels) the reporting function, and continues the movement restriction function. Accordingly, the movement of the shovel 100 by the remote operation can be decelerated, the remote operation can be prohibited, and the movement of the shovel 100 can be stopped by the movement restriction function, and thus, the safety of the shovel 100 can be further improved.

The safety control unit 3016 may prohibit (cancel) only a part of the movement restriction function and continue the remaining functions. Specifically, the safety control unit 3016 may prohibit only the movement restriction function of some of the plurality of driven elements, and may continue the movement restriction function of the remaining driven elements. For example, the safety control unit 3016 determines whether to prohibit or continue the movement restriction function for each driven element according to the position (direction) of the person authenticated by the authentication unit 3014 with respect to the shovel 100. Specifically, when the person is authenticated by the authentication unit 3014, the safety control unit 3016 may determine whether to continue the movement restriction function of the upper turning body 3 and prohibit the movement restriction function of the lower traveling body 1 or the attachment AT (the boom 4, the arm 5, and the bucket 6) according to the position of the person. This is because, when the upper turning body 3 turns, a person who exists in any direction as viewed from the shovel 100 may approach the upper turning body 3, but the directions in which the lower traveling body 1 and the attachment AT move are determined, and thus, the reduction in the safety is limited depending on the position of the person, even when the lower traveling body 1 and the attachment AT are moved. Thus, for example, the movement restriction function of the upper turning body 3 is continued for an authenticated person approaching from the side of the upper turning body 3, and the movement restriction of the attachment AT is prohibited while maintaining the safety of the shovel 100, whereby a reduction in the work efficiency of the shovel 100 can be prevented.

The safety control unit 3016 may prohibit (cancel) only a part of the functions of the reporting function and continue the remaining functions. Specifically, the safety control unit 3016 may prohibit a reporting function only for an authenticated person, from among the reporting functions, and may continue the reporting functions for other persons. For example, the reporting function through the portable terminal carried by the authenticated person (e.g., a worker, a supervisor, or a manager at the work site) is prohibited (canceled), and the alarm sound is set to be silent, while the reporting function through the portable terminal carried by another person is continued.

In addition, in a case of a person who has been authenticated by the authentication unit 3014, the safety control unit 3016 may relax (limit) the activation of the safety function of the shovel 100 compared to a case of other objects. For example, when the auditory reporting function is activated for a person who has been authenticated by the authentication unit 3014, the safety control unit 3016 relaxes the alarm level of the alarm sound to be output at a reduced level. For example, the level of the alert can be lowered by lowering the pitch or the sound pressure. For example, the safety control unit 3016 relaxes the degree of restriction on the movement of the shovel 100 when the movement restriction function is activated for a person who has been authenticated by the authentication unit 3014. For example, in a situation where the movement stop function is normally operated, the degree of restriction on the movement of the shovel 100 can be relaxed by activating the movement restriction function or reducing the deceleration degree of the movement restriction function. Thus, for example, even when the operator of the remote operation authenticated by the authentication unit 3014 needs to check the situation of the shovel 100, the situation of the ground surface subject to work by the shovel 100, or the like in the vicinity, it is possible to prevent a reduction in the work efficiency of the shovel 100.

Further, similarly to the case of prohibiting (canceling) the safety function, the safety control unit 3016 may relax the activation of only a part of the safety function.

In addition, in a case of a person who has been authenticated by the authentication unit 3014, the safety control unit 3016 may relax the activation condition of the shovel 100 compared to a case of other objects. Specifically, in the case of a person who has been authenticated by the authentication unit 3014, the safety control unit 3016 may relax the outer edge of the reporting range or the outer edge of the movement restriction range in a direction closer to the predetermined part of the shovel 100. Thus, for example, even when a person authenticated by the authentication unit 3014 approaches the shovel 100 to some extent, the safety function can be made less likely to be activated. Therefore, for example, even when the operator of the remote operation authenticated by the authentication unit 3014 needs to check the situation of the shovel 100, the situation of the ground surface subject work by the shovel 100, or the like in the vicinity, it is possible to prevent a reduction in the work efficiency of the shovel 100.

Further, similarly to the case of prohibiting (canceling) the safety function, the safety control unit 3016 may relax only some of the work conditions of the safety function.

In addition, when there is a person who has been authenticated by the authentication unit 3014, the safety control unit 3016 may notify information on an authenticated person through the output device 50. Thus, the controller 30 can notify the operator of the cabin 10 of the presence of the authenticated person through the output device 50. Therefore, for example, the safety control unit 3016 causes the output device 50 (display device) to display the presence of the person who has been authenticated by the authentication unit 3014 and the position information of the person. The safety control unit 3016 may cause the output device 50 to display information on a cancellation state or a mitigation state of the safety function for the authenticated person.

Similarly, when there is a person who has been authenticated by the authentication unit 3014, the safety control unit 3016 may notify an operator of the remote operation of information on the authenticated person through the display device 208 or the sound output device of the remote operation assistance device 300. In addition, when the operator of the remote operation has been authenticated, the operator of the remote operation may be notified of the information such that the information on the operator of the remote operation and the information on another authenticated person can be distinguished.

Similarly, the safety control unit 3016 may notify the worker, the supervisor, the manager, or the like at the work site of the information on the authenticated person through the display device or the sound output device of the terminal device carried by the worker, the supervisor, the manager, or the like at the work site. In addition, in a case where the person who carries the terminal device has been authenticated, the person who carries the terminal device (the worker, the supervisor, the manager, or the like at the work site) may be notified of the information so that the information on the carrier of the authenticated terminal device and the information on another authenticated person can be distinguished from each other.

The function of the safety control unit 3016 may be switched between ON (enabled) and OFF (disabled) in response to a predetermined input to the input device 52 or the input device 307 by the operator or the like.

### [Authentication Processing of Person Around Shovel]

Next, authentication processing of a person around the shovel 100, particularly, an operator of remote operation will be described.

FIG. 13 is a flowchart schematically illustrating an example of an authentication process of a person (operator of remote operation) around the shovel 100.

The flowchart of FIG. 13 is repeatedly executed at predetermined process intervals during the operation of the shovel 100 from the start to the stop of the shovel 100, for example. The flowchart of FIG. 13 may be repeatedly executed at the predetermined process intervals when the function of the safety control unit 3016 is ON (enabled) during the operation of the shovel 100.

As illustrated in FIG. 13, in step S102, the gesture recognition unit 3013 performs a process of recognizing a predetermined gesture of a person around the shovel 100 on the basis of outputs (captured images) of the imaging device 40.

When the process of step S102 is completed, the controller 30 proceeds to step S104.

In step S104, the authentication unit 3014 determines whether or not a gesture (an example of a first gesture) representing an authentication request has been recognized by the gesture recognition unit 3013.

The gesture representing the authentication request is, for example, defined in advance and registered in advance in the auxiliary storage device 30A or the like of the controller 30. The gesture representing the authentication request may include an action of approaching the shovel 100. Thus, even when the worker or the like working around the shovel 100 accidentally performs an action similar to the gesture representing the authentication request, the possibility that the action is recognized as the gesture representing the authentication request can be reduced. For example, the gesture recognition unit 3013 can determine whether or not a target object is performing the action of approaching the shovel 100 based on the history of the actual position estimated by the position estimation unit 3012.

The authentication unit 3014 proceeds to step S106 when the gesture recognition unit 3013 recognizes a gesture representing an authentication request, and ends the process of the flowchart in the other cases.

In step S106, the authentication unit 3014 transmits a request signal for requesting execution of a gesture for authentication (an example of a second gesture) to a predetermined terminal device in the area around the shovel 100 through the communication device 60.

The predetermined terminal device is a terminal device that can communicate with the shovel 100 through a predetermined communication line. The predetermined terminal device includes, for example, a terminal device carried by a worker, a supervisor, a manager, or the like at the work site of the remote operation assistance device 300 or the shovel 100. For example, the controller 30 can transmit a request signal to a predetermined terminal device by performing pairing with the predetermined terminal in advance based on a communication standard of short-range communication such as WiFi or Bluetooth (registered trademark) using the communication device 60.

For example, when the predetermined terminal device receives the request signal, the predetermined terminal device performs notification for prompting the gesture for authentication in a visual manner such as screen display or an auditory method such as voice output. Thus, for example, the operator of the remote operation can grasp that the gesture of the first step (gesture representing the authentication request) is recognized on the shovel 100 side, and can execute the gesture of the second step (gesture for authentication) according to the notification.

When the process of step S106 is completed, the controller 30 proceeds to step S108.

The process of step S106 may be omitted. In this may notify that the gesture case, the controller 30 representing the authentication request has been recognized or prompt the user to execute the gesture for authentication through the output device 50 (e.g., a display device or an illumination device) provided on the side surface or the like of the upper turning body 3.

In step S108, the gesture recognition unit 3013 performs a process of recognizing a predetermined gesture of a person around the shovel 100 based on outputs (captured images) of the imaging device 40.

When the process of step S108 is completed, the controller 30 proceeds to step S110.

In step S110, the authentication unit 3014 determines whether or not the gesture recognition unit 3013 recognizes a gesture for authentication performed by the same person as the gesture representing the authentication request.

The gesture for authentication is, for example, a given gesture different from an action (gesture) performed by a person in an area around the shovel 100. The gesture for authentication may be defined in advance and registered in advance in the auxiliary storage device 30A or the like of the controller 30.

For example, the gesture recognition unit 3013 can determine whether or not the recognized gesture is performed by the same person, based on the histories of the detection result by the object detection unit 3011 and the estimation result by the position estimation unit 3012, the position on the captured image where the gesture for authentication is recognized, and the like.

The authentication unit 3014 proceeds to step S112 when the gesture recognition unit 3013 does not recognize the gesture for authentication performed by the same person as the gesture representing the authentication request, and proceeds to step S114 when the gesture recognition unit 3013 recognizes the gesture for authentication.

In step S112, the authentication unit 3014 determines whether or not a time corresponding to the timeout has elapsed from a starting point for calculation set after the gesture recognition unit 3013 recognizes the gesture of the authentication request. The starting point for calculation may be, for example, the time of completion of the process of step S104 or the time of completion of the process of step S106. When the time corresponding to the timeout has not elapsed, the authentication unit 3014 returns to step S108. When the time corresponding to the timeout has elapsed, the authentication unit 3014 ends the process of the flowchart of this time.

Meanwhile, in step S114, the authentication unit 3014 completes the authentication of the person who has performed the gesture for authentication recognized by the gesture recognition unit 3013, and outputs the position information representing the actual position of the authenticated person. Thus, the tracking unit 3015 can track the actual position of the authenticated person.

When the process of step S114 is completed, the controller 30 ends the process of the flowchart of this time.

In this way, the controller 30 can authenticate a specific person by recognizing a two-step gesture performed by the specific person around the shovel 100.

This, for example, enables the specific person to be authenticated by the process with a lower load than the process of a case where the specific person is recognized and authenticated by an image. For example, as compared with a case where a specific person is authenticated only by recognition of a gesture of one step, it is possible to prevent a situation in which a person is authenticated by an accidental gesture and the safety of the shovel 100 is lowered.

### [Overview of Shovel Security System]

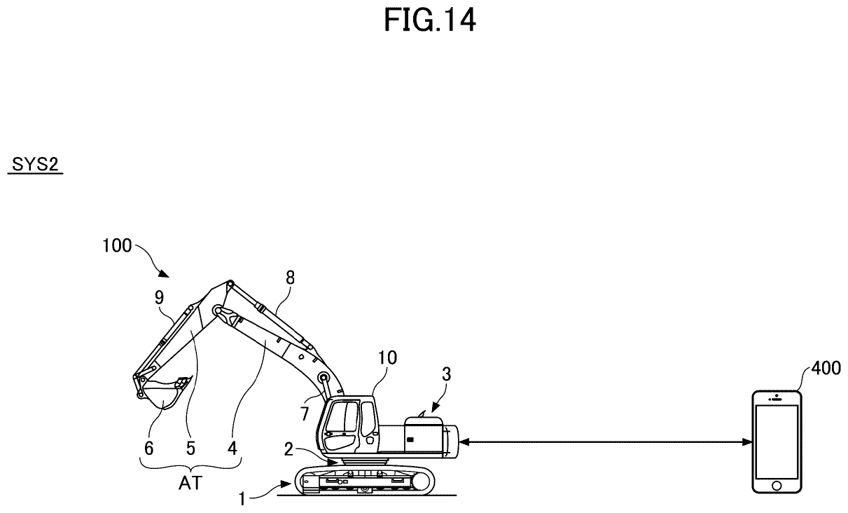

Next, an overview of the security system SYS2 of the shovel 100 will be described with reference to FIG. 14.

Hereinafter, the shovel 100 will be described focusing on portions different from those of the activation assistance system SYS and the remote operation system SYS1 described above, and the description of the same or corresponding contents as those of the remote operation system SYS1 may be omitted.

FIG. 14 is a diagram illustrating an example of the security system SYS2 of the shovel 100.

The security system SYS2 includes the shovel 100 and a terminal device 400.

The security system SYS2 ensures the security of the shovel 100. A person who carries the terminal device 400 capable of communicating with the shovel 100 is authenticated, and access to the shovel 100 and operation relating to the shovel 100 are permitted in a state where the person is authenticated. The access to the shovel 100 includes, for example, access to the cabin 10 of the shovel 100 and access to the inside of the upper turning body 3. The access to the cabin 10 includes, for example, unlocking and opening of the door of the cabin 10. The access to the inside of the upper turning body 3 includes unlocking and opening of doors provided on the side surface and the upper surface of the upper turning body 3 for accessing the engine room, the radiator room, the pump room, and the like. The access to the shovel 100 includes, for example, electrical access to the controller 30 or the like of the shovel 100 using a predetermined terminal such as the terminal device 400. The operation relating to the shovel 100 includes, for example, an operation for starting the shovel 100 such as a starting operation of a motor (engine 11), an operation of a driven element (actuator) of the shovel 100 (operation of the operation device 26), and the like. The security system SYS2 may distinguish between an authenticated person and other persons, and permit the authenticated person to access the shovel 100 or operate the shovel 100. On the other hand, the security system SYS2 operates to prevent access to the shovel 100 and operation on the shovel 100 in a state where a person is not authenticated. The security system SYS2 may operate to prevent access to the shovel 100 and operation of the shovel 100 by an unauthenticated person.

The shovel 100 is a work machine whose security is ensured by the security system SYS2.

The shovel 100 operates driven elements such as the lower traveling body 1 (that is, the pair of left and right crawlers 1C), the upper turning body 3, the boom 4, the arm 5, and the bucket 6 in response to an operation of an operator who boards the cabin 10.

Further, as in the case of the remote operation system SYS1 described above, the shovel 100 may be configured to be remotely operated from outside the shovel 100 instead of or in addition to being configured to be operable by the operator boarding the cabin 10.

The remote operation includes, for example, a mode in which the shovel 100 is operated by operation inputs relating to actuators of the shovel 100 performed by the remote operation assistance device 300 as in the case of the remote operation system SYS1 described above (see FIG. 10). However, unlike the case of the above-described remote operation system SYS1, the remote operation assistance device 300 may be provided at a place separated from the shovel 100 to some extent, for example, a management center or the like that manages the work of the shovel 100 from the outside of the work site.

Specifically, the shovel 100 may transmit an image (surrounding image) representing a surrounding area including the front of the shovel 100 based on the captured image output by the imaging device 40 to the remote operation assistance device 300 through the communication device 60, for example. Then, the remote operation assistance device 300 may cause the display device 208 to display the image (surrounding image) received from the shovel 100. Further, various information images (information screens) displayed on the output device 50 (display device) inside the cabin 10 of the shovel 100 may be displayed on the display device 208 of the remote operation assistance device 300 in the same manner. Thus, the operator who uses the remote operation assistance device 300 can check the display content such as the image or the information screen representing the surrounding area of the shovel 100 displayed on the display device 208. Therefore, the operator who uses the remote operation assistance device 300 can remotely operate the shovel 100 from a place where the operator cannot directly visually recognize the work of the shovel 100.

The shovel 100 may automatically operate the actuator regardless of the content of the operation by the operator. Thus, the shovel 100 can implement a function (“automatic operation function” or “machine control (MC) function”) of automatically operating at least some of the driven elements such as the lower traveling body 1, the upper turning body 3, the boom 4, the arm 5, and the bucket 6.

The automatic driving function includes, for example, a function (“semi-automatic driving function” or “operation assist type MC function”) of automatically operating a driven element (actuator) other than a driven element (actuator) to be operated in response to an operation or a remote operation by the operator on the operation device 26. The automatic driving function may include a function (“fully automatic driving function” or “fully automatic MC function”) of automatically operating at least some of a plurality of driven elements (actuators) on the assumption that there is no operation or no remote operation on the operation device 26 by the operator. In the shovel 100, when the fully automatic operation function is enabled, the inside of the cabin 10 may be in an unmanned state. In addition, the semi-automatic driving function, the fully automatic driving function, or the like may include a mode in which the operation content of a driven element (actuator) of an automatic driving target is automatically determined according to a rule defined in advance. The semi-automatic driving function, the fully automatic driving function, and the like may include a mode (“autonomous driving function”) in which the shovel 100 autonomously makes various determinations and the operation content of a driven element (actuator) to be automatically driven is autonomously determined according to the determination result.

In addition, when the shovel 100 has an automatic operation function, the work of the shovel 100 may be remotely monitored. In this case, a remote monitoring assistance device having the same function as the remote operation assistance device 300 may be provided. Thus, the monitoring person who is the user of the remote monitoring assistance device can monitor the working situation by the automatic driving function of the shovel 100 while checking the surrounding image displayed on the display device of the remote monitoring assistance device. Further, for example, when the monitoring person determines that the monitoring is necessary from the viewpoint of safety, the monitoring person can intervene in the automatic operation function of the shovel 100 and perform an emergency stop by performing a predetermined input using the input device of the remote monitoring assistance device.

The terminal device 400 is a portable terminal device, that is, a mobile terminal carried by a user of the shovel 100.

The terminal device 400 may be a dedicated mobile terminal for receiving the above-described authentication, or may be a general-purpose mobile terminal such as a smartphone or a tablet terminal. In the latter case, a dedicated application operable in coordination with the shovel 100 may be installed in advance.

### [Hardware Configuration of Security System]

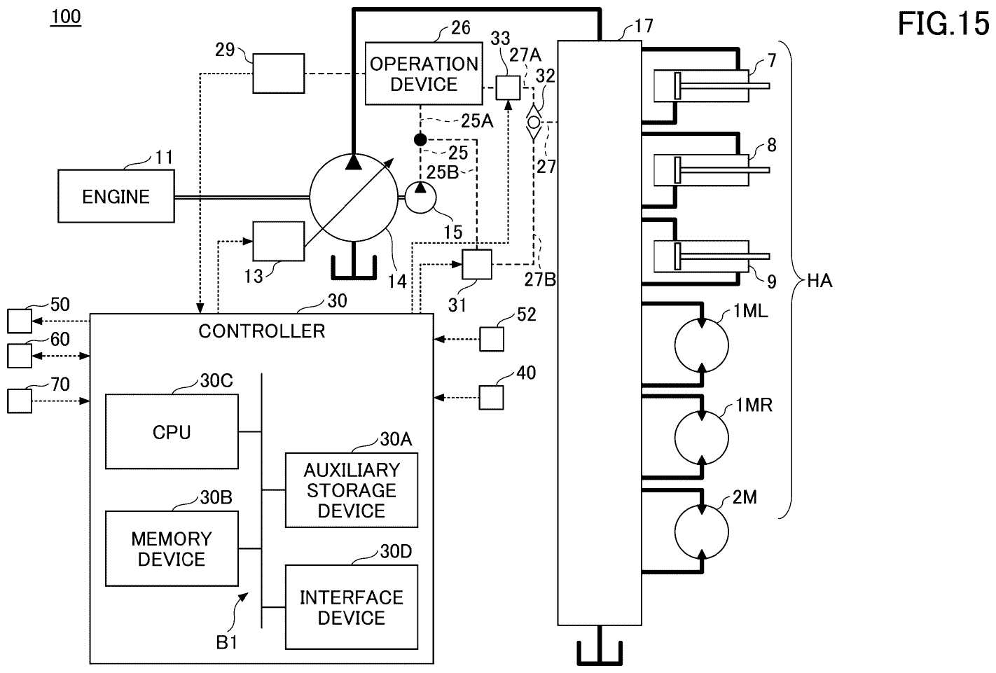

Next, a hardware configuration of the security system SYS2 will be described with reference to FIG. 15 in addition to FIG. 14.

The hardware configuration of the terminal device 400 may be the same as that of the remote operation assistance device 300 (FIG. 11). Therefore, illustration and description of the hardware configuration of the terminal device 400 will be omitted.

FIG. 15 is a block diagram illustrating another example of a hardware configuration of the shovel 100.

As illustrated in FIG. 15, a control system of the shovel 100 includes a controller 30. The control system of the shovel 100 includes the operation pressure sensor 29, the imaging device 40, and an imaging device 70.

The imaging device 70 is provided inside the cabin 10 and acquires an image representing a state inside the cabin 10.

For example, the imaging device 70 is a monocular camera. The imaging device 70 may be a 3D camera.

At least one of the imaging device 40 or the imaging device 70 may be omitted.

### [Functional Configuration of Security Function of Shovel]

Next, a functional configuration relating to a security function of the shovel 100 will be described with reference to FIG. 16.

FIG. 16 is a block diagram illustrating an example of a functional configuration relating to the security function of the shovel 100.

As illustrated in FIG. 16, the controller 30 includes the gesture recognition unit 3013, the authentication unit 3014, and a security control unit 3017.

The gesture recognition unit 3013 recognizes a predetermined gesture performed by a person around the shovel 100 based on an output data of the imaging device 40. The gesture recognition unit 3013 may recognize the predetermined gesture performed by a person inside the shovel 100 on the basis of the imaging device 70 (an example of a first sensor).

The authentication unit 3014 authenticates a specific person around the shovel 100, as in the case of being used for the surrounding monitoring function. The authentication unit 3014 may authenticate a person inside the cabin 10 of the shovel 100. The specific person is a regular user of the shovel 100. The authenticated user of the shovel 100 is, for example, an owner of the shovel 100, an operator of the shovel 100, a service person who performs the maintenance of the shovel 100, or the like.

Specifically, as described above, when a predetermined gesture is recognized by the gesture recognition unit 3013, the authentication unit 3014 performs authentication of a person who performs the predetermined gesture. More specifically, the authentication unit 3014 may authenticate the specific person around the shovel 100 by performing the same authentication process as that of FIG. 13 described above in conjunction with the gesture recognition unit 3013. In this case, the “predetermined terminal device” described above in the process of step S106 includes the terminal device 400.

The authentication unit 3014 recognizes a predetermined gesture performed by a person inside the cabin 10 of the shovel 100 based on the output data (captured image) of the imaging device 70, and thereby performs authentication of the person performing the predetermined gesture. More specifically, the authentication unit 3014 may authenticate the specific person inside the shovel 100 by executing the same authentication process as that of FIG. 13 described above in conjunction with the gesture recognition unit 3013.

The authentication unit 3014 may perform authentication by another method in addition to the authentication of a person by the predetermined gesture. In this case, the authentication by the predetermined gesture may be referred to as “first authentication” for convenience, and the authentication by another method may be referred to as “second authentication”.

The security control unit 3017 (an example of a second control unit) performs control relating to ensuring the security of the shovel 100. Specifically, when access to the shovel 100 or an operation relating to the shovel 100 is performed in a state where authentication by the authentication unit 3014 has not been completed, the security control unit 3017 activates the security function.

The security function includes, for example, a reporting function configured to report the reduced security to the surroundings of the shovel 100, that is, a possibility of theft or the like of the shovel 100 through the output device 50. The security function may include a reporting function configured to report the reduced security around the shovel 100 to a predetermined external device, that is, a possibility of theft or the like of the shovel 100 through the communication device 60. The predetermined external device is, for example, a terminal device carried by a user of the shovel 100, a server device of a management center that manages the shovel 100 from the outside, or the like.

Further, for example, the security function includes a function (hereinafter, referred to as “activation disabling function”) of disabling an activation operation of the shovel 100 and setting the shovel 100 to an activation disabled state regardless of the presence or absence of various operations.

Further, for example, the security function includes a movement stopping function of forcibly maintaining the solenoid switching valve 25V on the most upstream side of the pilot line 25 in the shutoff state and maintaining the shovel 100 in a movement stopped state regardless of the presence or absence of various operations.

In addition, the security control unit 3017 prohibits the activation of the security function and permits access to the shovel 100 or an operation relating to the shovel 100 in a state where the authentication has been completed by the authentication unit 3014.

In addition, when the first authentication and the second authentication are performed by the authentication unit 3014, the security control unit 3017 may relax the activation of the security function in a state where the first authentication has completed by the been authentication unit 3014. Then, the authentication unit 3014 prohibits the activation of the security function and permits all the access to the shovel 100 and the operation relating to the shovel 100 in a state where the second authentication is further completed. For example, the security control unit 3017 relaxes the operation of the security function in a mode in which the reporting function is prohibited and the activation disabling function or the movement stop function is operated in a state in which the first authentication has been completed by the authentication unit 3014.

In addition, when the first authentication and the second authentication are performed by the authentication unit 3014, the security control unit 3017 may relax the activation condition of the security function in a state where the first authentication has been completed by the authentication unit 3014. Then, in a state where the authentication unit 3014 has further completed the second authentication, for example, the security control unit 3017 prohibits the activation of the security function and permits all of the access to the shovel 100 and the operation relating to the shovel 100. For example, the security control unit 3017 relaxes the activation condition of the security function in a mode in which the access to the cabin 10 or the like of the shovel 100 is permitted in a state in which the first authentication has been completed by the authentication unit 3014 while the operation relating to the shovel 100 is prohibited.

In this way, as in the case of the remote operation system SYS1, the controller 30 can authenticate a specific person by recognizing the two-step gesture performed by the specific person around the shovel 100.

This allows, for example, a specific person to be authenticated by a less burdensome process than, for example, when a specific person is recognized and authenticated by an image. Further, for example, as compared with a case where a specific person is authenticated only by recognition of a gesture of one step, it is possible to prevent a situation where a person is authenticated by an accidental gesture and the security of the shovel 100 is lowered.

### [Other Examples of Remote Operation System and Security System]

Next, other examples of the remote operation system SYS1 and the security system SYS2 will be described.

The embodiments relating to the remote operation system SYS1 and the security system SYS2 described above may be combined, modified, or changed as appropriate.

For example, hardware similar to the imaging devices 40 and 70 and the distance sensor of the shovel 100 and a function similar to the authentication unit 3014 of the shovel 100 in the above-described embodiment may be mounted on various devices that require authentication of a user. The various devices include electronic devices, industrial machines, automobiles, and the like. The electronic device includes, for example, an information processing device such as a terminal device or a server device.

### [Operation]

Next, the operation of the work machine (shovel 100) in the remote operation system SYS1 and the security system SYS2 according to the present embodiment will be described.

In the present embodiment, the work machine (e.g., the shovel 100) includes a first sensor (e.g., the imaging device 40, the distance sensor, or the imaging device 70), a recognition unit (e.g., the gesture recognition unit 3013), and an authentication unit (e.g., the authentication unit 3014). Specifically, the first sensor acquires information on an object around the work machine or inside the cabin (e.g., the cabin 10). The recognition unit recognizes a gesture of a person around the work machine or inside the cabin based on the output of the first sensor. Then, the authentication unit authenticates the person when the recognition unit recognizes a first gesture of the person around the work machine or inside the cabin 10 and then the recognition unit recognizes a second gesture of the same person.

Conventionally, a technique is known in which various devices can be operated by a gesture of a person from the outside (e.g., see WO 2020/032267).

The above-described document discloses a shovel configured to recognize a worker around the work machine and be operable by a predetermined gesture from the worker. This can improve the convenience of the user.

However, in a case where the work machine can be operated by a predetermined gesture, and a plurality of persons are recognized by the work machine, the predetermined gesture performed by a person different from a particular operator may be recognized by the work machine, causing the work machine to move regardless of the intention of that person. Further, for example, there is a possibility that a malicious third party who happens to know that a predetermined gesture can be used to operate the device may misuse the gesture-based operation function.

In contrast, in the present embodiment, the work machine (e.g., the controller 30) can perform authentication of a person by gesture in two steps. Therefore, for example, even if the first gesture is recognized by accident, the second gesture is further required, and thus it is possible to prevent a situation in which the work machine is moved regardless of the intention of the person who performs the first gesture. Further, for example, even if information on one of the first gesture or the second gesture is leaked, the other gesture is necessary, and thus it is possible to prevent a situation in which an operation function by a gesture is misused. Therefore, safety and security of the work machine can be more appropriately ensured.

In the present embodiment, the second gesture may be a gesture different from an action performed by another person present around the work machine or inside the cabin 10.

This can prevent a situation in which a plurality of users are simultaneously authenticated. Further, for example, a user of the work machine who desires to be authenticated may memorize only the first gesture defined in advance, and thus, it is possible to improve the convenience of the user.

In the present embodiment, the first gesture may include an action of a person around the work machine approaching the work machine.

Thus, for example, even in a situation where there are a large number of workers who are performing work around the work machine, it is possible to reliably recognize the first gesture of a person who intends to be authenticated.

In the present embodiment, the work machine may include a second sensor (e.g., the imaging device 40 or a distance sensor), a detection unit (e.g., the object detection unit 3011), and a first control unit (e.g., the safety control unit 3016). Specifically, the second sensor may acquire information on an object around the work machine. The second sensor may be the same as or different from the first sensor when the first sensor acquires information on an object around the work machine. The detection unit may detect a person around the work machine based on the output of the second sensor. The first control unit may activate a predetermined safety function when a person has been detected within a predetermined range around the work machine by the detection unit. The first control unit may prohibit the activation of the predetermined safety function when the detection unit detects the person authenticated by the authentication unit. The first control unit may relax the activation of the predetermined safety function when the detection unit detects the person authenticated by the authentication unit. The first control unit may relax the activation condition of the predetermined safety function when the detection unit detects the person authenticated by the authentication unit.

Thus, for example, an operator, a supervisor, or the like of the remote operation of the work machine can check the working situation or the like near the work machine while preventing a reduction in work efficiency due to the activation of the safety function of the work machine by receiving the authentication by the gesture. Therefore, it is possible to improve the convenience of an operator, a supervisor, or the like of the remote operation around the work machine.

In the present embodiment, the predetermined safety function may include a reporting function configured to report that a person has been detected within a predetermined range around the work machine. The first control unit may prohibit or relax activation of, or relax an activation condition of a part of the reporting function when the person authenticated by the authentication unit has been detected by the detection unit.

This makes it possible to more appropriately achieve both the convenience of an operator of remote operation, a supervisor, or the like around the work machine and the safety of the work machine.

In the present embodiment, the reporting function may include a first reporting function configured to report to at least one of the operator of the work machine or the surroundings of the work machine, and a second reporting function configured to report to a person detected by the detection unit. The first control unit may prohibit or relax the activation of, or relax the activation condition of only the second reporting function, from among the first reporting function and the second reporting function when the person authenticated by the authentication unit has been detected by the detection unit.

This makes it possible to more appropriately ensure the safety of the work machine by continuing the first reporting function while improving the convenience of the authenticated person such as an operator or a supervisor of the remote operation around the work machine by the prohibition of the second reporting function or the like.

In the present embodiment, the predetermined safety function may include a movement restriction function for restricting the operation of the work machine. The first control unit may prohibit or relax the activation of, or relax the activation condition of a part of the movement restriction function when the person authenticated by the authentication unit has been detected by the detection unit.

This makes it possible to more appropriately achieve both the work efficiency of the work machine and the safety of the work machine.

In the present embodiment, the work machine may include a lower traveling body (e.g., the lower traveling body 1), an upper turning body (e.g., the upper turning body 3) mounted on the lower traveling body so as to be turnable, and an attachment (e.g., the attachment AT) attached to the upper turning body. The movement restricting function may include a first movement restricting function of restricting the movement of the upper turning body and a second movement restricting function of restricting the movement of the attachment. The first control unit may prohibit or relax activation of, or relax the activation condition of only the second movement restriction function, from among the first movement restriction function and the second movement restriction function when the person authenticated by the authentication unit has been detected by the detection unit.

This enables the work of the work machine to continue by the prohibiting, for example, the second movement restriction function or the like, thereby preventing a reduction in the work efficiency of the work machine, while the safety of the work machine can be more appropriately ensured by continuing the first movement restriction function.

In the present embodiment, the work machine may include a communication device (e.g., the communication device 60). Specifically, the communication device may be configured to communicate with a terminal device (e.g., the remote operation assistance device 300 or the terminal device 400) carried by the user of the work machine. When the first gesture is recognized, the recognition unit may transmit a signal requesting the second gesture to the terminal device through the communication device.

This allows the user of the work machine to better understand the timing of the execution of the second gesture.

In the present embodiment, the operation of the work machine may be remotely controlled in response to a signal from a terminal device (e.g., the remote operation assistance device 300).

Thus, an operator who remotely operates the work machine using a terminal device in the vicinity of the work machine to approach the work machine while preventing a reduction in work efficiency due to activation of the safety function of the work machine. Therefore, the working situation of the work machine, the status of the work machine, and the like can be more appropriately checked. Therefore, the operator of the remote operation can more appropriately perform the remote operation of the work machine.

In the present embodiment, the work machine may include a second control unit (e.g., the security control unit 3017). Specifically, the second control unit may activate a predetermined security function for access to or operation of the work machine. The second control unit may prohibit activation of the predetermined security function for access to or operation of the work machine by the person authenticated by the authentication unit. The second control unit may relax activation of the predetermined security function for access to or operation of the work machine by the person authenticated by the authentication unit. The second control unit may relax the activation condition of the predetermined security function for access to or operation of the work machine by the person authenticated by the authentication unit.

Thus, for example, the user of the work machine can cancel or relax the security function by authentication by gesture. Therefore, it is possible to improve the convenience of the user of the work machine while ensuring the security of the work machine.

Although the embodiments have been described in detail, the present disclosure is not limited to such specific embodiments, and various modifications and changes may be made within the scope of the gist described in the claims.

For example, the shovel 100 may be all the components of the activation assistance system SYS, the remote operation system SYS1, and the security system SYS2, may be any two components, or may be any one component.

Although the embodiments of the present disclosure have been described above in detail, the present disclosure is not limited to such specific embodiments, and various alterations and modifications are possible within the scope of the claims as recited.

What is claimed is:

1. A work machine comprising:
circuitry configure to:
receive an operation input by a user with respect to the work machine;
receive an instruction relating to an operation of the work machine from outside the work machine; and
notify the user of the received instruction relating to the operation of the work machine.

2. The work machine according to claim 1,
wherein the instruction relating to the operation of the work machine includes at least one of
a first instruction for an operation of specifying a driven element of the work machine and operating the driven element in a specific direction,
a second instruction for an operation of specifying a movement constituting a work item and executing the movement,
a third instruction for an operation of adjusting a movement speed of the work machine, or
a fourth instruction relating to a procedure of a plurality of movements or a procedure of a plurality of work items.

3. The work machine according to claim 1,
wherein the circuitry receives the instruction relating to the operation of the work machine from an instructor around the work machine.

4. The work machine according to claim 3,
wherein the circuitry recognizes a gesture representing the instruction relating to the operation of the work machine from the instructor, based on sensing information representing a surrounding area of the work machine, to receive the instruction relating to the operation of the work machine.

5. The work machine according to claim 1, wherein the circuitry is further configured to:
report to the user when there is a discrepancy between a content of the instruction relating to the operation of the work machine provided by notification and a content of a subsequent actual operation input to the work machine.

6. The work machine according to claim 1, wherein the circuitry is further configured to:
record a log in a predetermined storage unit, when there is a discrepancy between a content of the instruction relating to the operation of the work machine provided by notification and a content of a subsequent actual operation input to the work machine, the log representing the discrepancy.

7. The work machine according to claim 1, further comprising:
a first sensor configured to acquire information relating to an object around the work machine or inside a cabin,
wherein the circuitry is further configured to:
recognize gestures of a person around the work machine or inside the cabin, based on an output of the first sensor; and
authenticate the person around the work machine when the circuitry recognizes a first gesture of the person and then the circuitry recognizes a second gesture of a same person.

8. The work machine according to claim 7,
wherein the second gesture is a gesture different from an action performed by another person present around the work machine or inside the cabin.

9. The work machine according to claim 7,
wherein the first gesture includes an action of the person around the work machine approaching the work machine.

10. The work machine according to claim 7, further comprising:
a second sensor configured to acquire information relating to an object around the work machine,
wherein the circuitry is further configured to:
detect a person around the work machine, based on an output of the second sensor; and
activate a predetermined safety function when the person has been detected within a predetermined range around the work machine, and
wherein the circuitry
prohibits the activation of the predetermined safety function when the authenticated person has been detected within the predetermined range around the work machine,
relaxes the activation of the predetermined safety function when the authenticated person has been detected within the predetermined range around the work machine, or
relaxes an activation condition of the predetermined safety function when the authenticated person has been detected within the predetermined range around the work machine.

11. The work machine according to claim 10,
wherein the predetermined safety function includes a reporting function configured to report that a person has been detected within the predetermined range, and
wherein the circuitry
prohibits or relaxes activation of, or
relaxes an activation condition of:
a part of the reporting function when the authenticated person has been detected within the predetermined range around the work machine.

12. The work machine according to claim 11,
wherein the predetermined safety function includes
a first reporting function configured to report to at least one of an operator of the work machine or surroundings of the work machine, and
a second reporting function configured to report to the detected person, and
wherein the circuitry prohibits or relaxes activation of, or relaxes an activation condition of only the second reporting function, from among the first reporting function and the second reporting function when the authenticated person has been detected within the predetermined range around the work machine.

13. The work machine according to claim 7, further comprising:
a communication device configured to communicate with a terminal device carried by a user of the work machine,
wherein the circuitry transmits a signal for requesting the second gesture to the terminal device through the communication device when the first gesture is recognized.

14. The work machine according to claim 13,
wherein a movement of the work machine is remotely operated, in response to a signal from the terminal device.

15. The work machine according to claim 7,
wherein the circuitry is further configured to:
activate a predetermined security function for access to or operation of the work machine, and
wherein the circuitry
prohibits the activation of the predetermined security function for access to or operation of the work machine by the authenticated person,
relaxes the activation of the predetermined security function for access to or operation of the work machine by the authenticated person, or
relaxes an activation condition of the predetermined security function for access to or operation of the work machine by the authenticated person.
